(19) United States
(12) Patent Application Publication
(10) Pub. No.: US 2025/0251175 A1
(43) Pub. Date: Aug. 7, 2025

(54) FRACTAL TEXTURED HIGH EFFICIENCY SOLAR ABSORBER COATINGS

(71) Applicant: VIRGINIA TECH INTELLECTUAL PROPERTIES, INC., Blacksburg, VA (US)

(72) Inventors: Ranga Pitchumani, Herndon, VA (US); Sibin Kunhi Purayil, Blacksburg, VA (US)

(21) Appl. No.: 18/856,122

(22) PCT Filed: Apr. 11, 2023
(86) PCT No.: PCT/US2023/018223

§ 371 Date: Oct. 11, 2024

Related U.S. Application Data
(60) Provisional application No. 63/329,842, filed on Apr. 11, 2022.

(51) Int. Cl. F24S 70/25; C01G 45/1221; C01G 51/40; C25D 9/04

(52) U.S. Cl. CPC F24S 70/25; C01G 45/1221; C01G 51/40; C01P 2004/03; C01P 2006/40; C01P 2006/60; C25D 9/04

(57) ABSTRACT

In one aspect, the disclosure relates to a solar absorber comprising light-absorbing multiscale fractal textured surfaces. The disclosure also relates to methods of making the same.

### CROSS-REFERENCE TO RELATED APPLICATIONS

This Application claims the benefit of U.S. Provisional Application No. 63/329,842, filed on Apr. 11, 2022, which is incorporated herein by reference in its entirety.

### STATEMENT REGARDING FEDERALLY SPONSORED RESEARCH

This invention was made with government support under the U.S. Department of Energy's Office of Energy Efficiency and Renewable Energy (EERE), under the Solar Energy Technologies Office Award Number DE-EE0008537. The government has certain rights in the invention.

### BACKGROUND

Solar energy is the most potent and limitless energy available on earth. Sun continuously delivers 1.2×10⁵ terawatts of energy to the earth, which is much higher than the whole world consumes in a year [1]. Efficiently converting solar rays into useful energy such as electrical or thermal energies may reduce reliance on nonrenewable energy sources such as coal, gasoline, and others, which emit the majority of carbon and air polluting gases and contribute to global warming, which is one of the most severe risks to the entire human population [2,3].

Solar photovoltaic and solar thermal conversions are two main solar energy harvesting methods. Solar photovoltaic converstion is already well established and commercialized [4-6]. Solar thermal conversion, such as concentrated solar power (CSP) operating at high temperatures, is more efficient than solar photovoltaic conversion; however, due to the lack of highly efficient high temperature stable solar absorbing materials to absorb solar radiation effectively and the high Levelized cost of energy of solar thermal conversion, they still lag behind the solar photovoltaic method [2,7].

The solar absorber efficiency of the absorber (η) weighs the absorbed energy and re-emitted energy of a surface against the total solar irradiance. Solar absorber efficiency can be measured as the ratio of solar energy absorbed and retained by a surface to the energy absorbed and retained by an ideal solar absorber with an absorptance value of unity and zero thermal emittance [8,9] according to equation (1);

$$η = \frac{α Q - εσ {T}^{4}}{Q} \qquad ( 1 )$$

where α is the average solar absorptance of the surface, Q is the solar irradiance on the receiver (W/m²), T is the temperature of the absorber surface in Kelvin, ε is the emittance of the coating at the temperature T, and σ is the Stefan-Boltzmann constant (5.67×10⁻⁸ W/m²/K⁴).

From the above equation, it is evident that absorber efficiency can be maximized by increasing the absorptance of the coating, solar concentration levels and minimizing the thermal emittance. A recent theoretical study showed that an efficient absorber with a cut-off wavelength at 2475 nm could convert the solar radiation to thermal energy with 98.3% efficiency at a 1000 sun concentration level [10].

Several extensive studies on solar selective coatings were done in the past. Researchers have succeeded in designing solar selective coatings by preparing refractive index matching nano-structured and multilayered coatings and engineering the plasmonic properties of materials at the expense of high preparation costs and low-temperature stability in the air; most of them work in vacuum conditions only [11-13]. As a result, to ensure the success of concentrated solar power (CSP) receivers, advanced absorber coatings with ultra-high absorptance and high-temperature stability in the air at high sun concentration levels must be developed at a low cost.

Many researchers have observed that intrinsic black oxide coatings that seem less efficient in low temperatures are efficient in high-temperature applications [14-18]. Mixed oxides of copper and other metals such as cobalt and manganese have been discovered to be ideal candidates for CSP applications [16-19]. Those coatings demonstrated very high-temperature stability in the air; however, their lack of solar selectivity and high preparation cost are critical disadvantages of those materials. Moreover, the absorptance of the coating was insufficient for CSP application.

Many recent theoretical and experimental studies revealed that ultra-high absorptance could be achieved by preparing textured micro-nano multi-scale surfaces of black absorbers [11,16,20]. As per the literature, various texturing methods are used to achieve high solar absorptance; these approaches involve sacrificial bead processes, micro-nano imprinting, lithography, and laser sintering, among others; however, these procedures are inconsistent and include many preparation steps, which may contribute to rising manufacturing costs.

In the past, electrodeposition has been used to fabricate uniform smooth surfaces, but in this application, the fractal forming of alloy coatings by electrodeposition were effected. Recently, it was demonstrated that electrodeposition was an effective approach for creating fractal coatings that can improve solar absorber. However much work needs to be done to improve the parameters of optimal conditions to prepare and utilizes such coatings.

Thus, there a remains a need to prepare maximally efficient solar absorbers. There is also a need to prepare efficient solar absorbers that are resilient to the extreme conditions of thermal solar generation, e.g., of CSP solar energy generation.

### SUMMARY

In accordance with the purpose(s) of the disclosure, as embodied and broadly described herein, the disclosure, in one aspect, includes a solar absorbing material comprising a substrate with an annealed coating comprising an electrodeposited metal oxide layer comprising two metals, wherein the metals are selected from the group consisting of cobalt (Co), copper (Cu), chromium (Cr), iron (Fe), manganese (Mn), and nickel (Ni), on a surface of the substrate wherein the metal oxide layer is multiscale fractal textured and wherein the solar efficiency of the solar absorbing material is from 90% to 99%.

Also disclosed is a method of making the solar absorbing material comprising: contacting the substrate with an aqueous solution comprising dissolved salts of two or more metals, wherein the aqueous solution is in contact with a first counter electrode, a working electrode, and a reference electrode; and applying a first voltage across the working electrode and counter electrode for a first period of time sufficient to deposit a first metal oxide layer on the substrate, wherein the first metal oxide layer comprises the two or more metals.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows graphs of absorptance of single-layer coatings of CuMnO and CuCoO on various substrates.

FIG. 2 shows graphs of emittance of single-layer coatings of CuMnO and CuCoO on various substrates.

FIG. 3 shows graphs of percent efficiency of single-layer coatings of CuMnO and CuCoO on various substrates.

FIG. 4 shows graphs of absorptance of single-layer single metal oxide coatings on Inconel 625.

FIG. 5 shows graphs of emittance of single-layer single metal oxide coatings on Inconel 625.

FIG. 6 shows graphs of percent efficiency of single-layer single metal oxide coatings on Inconel 625.

FIG. 7 shows graphs of absorptance of single-layer double metal oxide coatings on Inconel 625.

FIG. 8 shows graphs of emittance of single-layer double metal oxide coatings on Inconel 625.

FIG. 9 shows graphs of percent efficiency of single-layer double metal oxide coatings on Inconel 625.

FIG. 10 shows graphs of absorptance of single-layer triple metal oxide coatings on Inconel 625.

FIG. 11 shows graphs of emittance of single-layer triple metal oxide coatings on Inconel 625.

FIG. 12 shows graphs of percent efficiency of single-layer triple metal oxide coatings on Inconel 625.

FIG. 13 shows comparison graphs of absorptance of single-layer CuMnO and CuCoO coatings on Inconel 625 according to the surface treatment of the Inconel 625.

FIG. 14 shows comparison graphs of emittance of single-layer CuMnO and CuCoO coatings on Inconel 625 according to the surface treatment of the Inconel 625.

FIG. 15 shows comparison graphs of percent efficiency of single-layer CuMnO and CuCoO coatings on Inconel 625 according to the surface treatment of the Inconel 625.

FIG. 16 shows an FESEM image of a CoNiO-three-layer coating after a potentiostatic-based deposition of the first layer at 1.3 V, the second layer at 0.9 V, and the third layer at 0.7 V, with subsequent annealing.

FIG. 17 shows a second FESEM image of the three-layer coating of FIG. 16 at a higher resolution than FIG. 16.

FIG. 18 shows a third FESEM image of the three-layer coating of FIG. 16 at a higher resolution than FIG. 17.

FIG. 19 shows a fourth FESEM image of the three-layer coating of FIG. 16 at a higher resolution than FIG. 18.

FIG. 20 shows an FESEM image of a CoNiO-three-layer coating after a galvanostatic deposition of the first layer at 0.08 A, the second layer at 0.02 A, and the third layer at 0.005 A, with subsequent annealing.

FIG. 21 shows a second FESEM image of the three-layer coating of FIG. 20 at a higher resolution than FIG. 20.

FIG. 22 shows a third FESEM image of the three-layer coating of FIG. 20 at a higher resolution than FIG. 21.

FIG. 23 shows a fourth FESEM image of the three-layer coating of FIG. 20 at a higher resolution than FIG. 22.

FIG. 24 shows graphs of absorptance of a single-layer coating of CuMnO on Inconel 625 as dependent on concentrations of Cu and Mn cations and as a function of deposition voltage.

FIG. 25 shows graphs of emittance of a single-layer coating of CuMnO on Inconel 625 as dependent on concentrations of Cu and Mn cations and as a function of deposition voltage.

FIG. 26 shows graphs of efficiency of a single-layer coating of CuMnO on Inconel 625 as dependent on concentrations of Cu and Mn cations and as a function of deposition voltage.

FIG. 27 shows graphs of absorptance of a single-layer coating of CuCoO on Inconel 625 as dependent on concentrations of Cu and Co cations and as a function of deposition voltage.

FIG. 28 shows graphs of emittance of a single-layer coating of CuCoO on Inconel 625 as dependent on concentrations of Cu and Co cations and as a function of deposition voltage.

FIG. 29 shows graphs of efficiency of a single-layer coating of CuCoO on Inconel 625 as dependent on concentrations of Cu and Co cations and as a function of deposition voltage.

FIG. 30 is a perspective view of an electrochemical cell showing the working electrode (W.E) which is an Inconel 625 cylinder of outer diameter OD, a cylindrical platinum counter electrode (C.E.), the outer surface spaced at distance D_{w} from the OD; and a silver/silver chloride reference electrode (R.E.) wherein the R.E. is spaced at distance D_{R} from the C.E.

FIG. 31 shows an FESEM image of a three-layer coating of CoNiO prepared using the device of FIG. 30 wherein D_{R} is 1 cm and D_{w} is 1 cm.

FIG. 32 shows an FESEM image of a three-layer coating of CoNiO prepared using the device of FIG. 30 wherein D_{R} is 3 cm and D_{w} is 1 cm.

FIG. 33 shows an FESEM image of a three-layer coating of CoNiO prepared using the device of FIG. 30 wherein D_{R} is 5 cm and D_{w} is 1 cm.

FIG. 34 shows an FESEM image of a three-layer coating of CoNiO prepared using the device of FIG. 30 wherein D_{R} is 1 cm and D_{w} is 1 cm.

FIG. 35 shows an FESEM image of a three-layer coating of CoNiO prepared using the device of FIG. 30 wherein D_{R} is 1 cm and D_{w} is 2 cm.

FIG. 36 shows an FESEM image of a three-layer coating of CoNiO prepared using the device of FIG. 30 wherein D_{R} is 1 cm and D_{w} is 3 cm.

FIG. 37 shows a graph of the absorptance of a CoNiO three-layer coating on an Inconel 625 tube of OD 19.05 mm from 200 to 2500 nm wavelengths at D_{R}=1, 3, 5 cm.

FIG. 38 shows a graph of average absorptance of the coating of FIG. 37 as a function of D_{R}.

FIG. 39 shows a graph of the absorptance of a CoNiO three-layer coating on an Inconel 625 tube of OD 19.05 mm from 200 to 2500 nm wavelengths at D_{w}=1, 2, 3 cm.

FIG. 40 shows a graph of average absorptance of the coating of FIG. 37 as a function of D_{w}.

FIG. 41 shows an absorptance graph of a three layer-coated CoNiO Inconel 625 tube before and after heat treatment at 750° C. for 100 hours.

FIG. 42 shows a perspective view of the device used in the Irradiance Cycle Test.

FIG. 43 shows pictures of a three-layer-coated CoNiO Inconel 625 tube before and after 1000 cycles of the Irradiance Cycle Test along with an indication of essentially no difference between the absorbances of the tubes.

FIG. 44 shows pictures of the commercial material Pyromark® tested in the Irradiance Cycle Test, for less than 20 cycles, as found in the AIP Conference Proceedings 2126, 030002 (2019) (downloaded from https://aip.scitation.org/doi/pdf/10.1063/1.5117514.)

FIG. 45 shows a schematic view of the device used to perform the Thermal Shock Test.

FIG. 46 inset panels (a-c) show SEM images of an electrodeposited coating surface at increasing magnifications from panel a to panel c.

FIG. 47 shows a representative profilometric line scan of the surface revealing self-affine characteristic of smaller length scale asperities being uncovered upon repeated higher magnification.

FIG. 48 shows a Fast Fourier transform (FFT) based power spectrum of the surface in FIG. 46(a), showing the fractal characteristics of the surface over a frequency range.

FIG. 49 shows a pictoral description of the optical model: Panel (a) is an illustration of texture absorber surfaces based on the W-M function at different fractal dimensions; Panel (b) shows a schematic of the computational domain.

FIG. 50 shows spectral variation of reflectance of CuMnO coatings at different incidence angles, for various combinations of fractal dimension, D, and scaling constant, G.

FIG. 51 shows variation of spectrally averaged absorptance with incidence angle for different combinations of fractal dimension, D, and scaling constant, G.

FIG. 52 shows SEM images at two different magnifications showing the morphologies of electrodeposited CuO coatings fabricated at (Panels a,b) 0.7 V, (Panels c,d) 0.9 V and (Panels e,f) 1.1 V.

FIG. 53 shows SEM images at three different magnifications showing the morphologies of electrodeposited CuMnO coatings fabricated at (Panels a,b,c) 0.9 V, (Panels d,e,f) 1.0 V and (Panels g,h,i) 1.1 V.

FIG. 54 shows variation of the fractal dimension of CuO and CuMnO surfaces electrodeposited at various voltages.

FIG. 55 shows a comparison of experimental and simulation results re CuO coatings: Panel (a) shows spectral variation of reflectance (b) shows spectral average absorptance.

FIG. 56 shows a comparison of experimental and simulation results re CuMnO coatings: Panel (a) shows spectral variation of reflectance and Panel (b) shows spectral average absorptance.

FIG. 57 shows changes in absorber efficiency after (a) the adhesion test and (b) the water endurance test of CuMnO and CuCoO deposited at different electrodeposition voltages.

FIG. 58 is a graph showing the mechanical durability and maintenance of absorptance of the fractal textured coatings.

FIG. 59 is a graphic showing the comparison of the fractal textured solar absorber to other absorbers.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Nanostructure

The term “nanostructure” is in general a description of structures that are from about 1 to 100 nm in any one dimension. In general, the term nanostructure may mean that the nanostructure includes multiscale fractal texturing. The nanostructure may be characterizes as a light-absorbing multiscale fractal textured surface.

The nanostructure of the at least two-metal oxide layer(s) of the present disclosure may mean that the layer(s) form a textured absorber with a multiscale morphology, which may be represented as a fractal surface described by the Weierstrass-Mandelbrot (W-M) function [21,22], whose parameters can be obtained uniquely from a profilometric scan of an actual absorber surface without any assumed parameters. The fractal surface description is scale-invariant and overcomes the limitations of conventional measures of a rough surface [26].

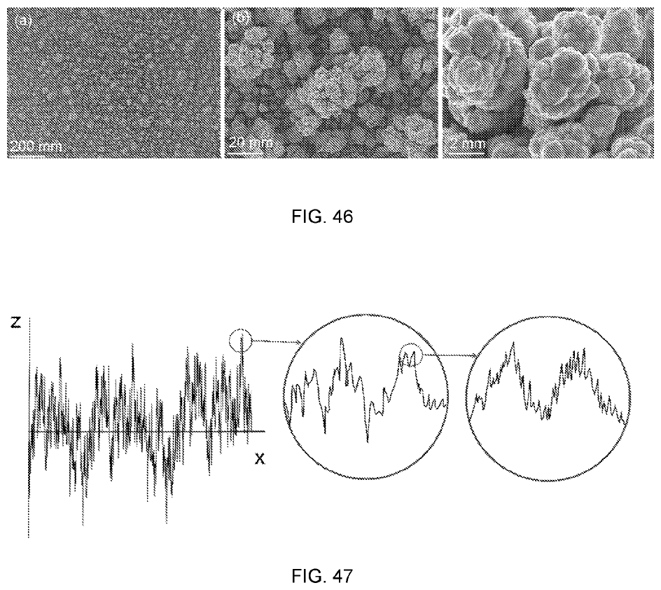

Solar selective coatings fabricated using typical methods show roughness features at multiple length scales, ranging from micrometers to nanometers. FIG. 46, panels a to c, show the scanning electron microscope (SEM) images of an electrodeposited copper surface at progressively increasing magnifications. The images reveal asperities at several length scales distributed uniformly over the surface.

Thus a fractal structure, or fractal surface, which terms may be interchangeable, may be defined, e.g., as the presence of smaller length scale asperities progressively layered on top of larger length scale asperities, observable with increasing magnification. Furthermore, asperities at smaller length scales appear with magnification, as seen in the insets of the profilometric scan of the surface presented in FIG. 47, where the magnified details of the profile are not a copy of the initial profile but a scaled one with different scaling factors at different magnifications. Therefore, the surface profiles under study are self-affine in nature.

Such a profile, z(x), may be considered as a superimposition of multiple waves of different wavelengths and amplitudes at different (random) phases and may be represented by the Weierstrass-Mandelbrot (W-M) function [21,22], given below, which contains the principal characteristics of rough multiscale surfaces namely, self-similarity, non-differentiability, and continuity:

$$z ( x ) = {G}^{D - 1} {\sum }_{n = {n}_{1}}^{∞} \frac{cos ( 2 {πγ}^{n} x )}{{γ}^{( 2 - D ) n}} \qquad ( 1 )$$

where x is the lateral distance, D is the fractal dimension, G is a scaling constant, γⁿ is a frequency mode corresponding to the horizontal length-scale dimension (L) of roughness feature as

$${γ}^{n} = \frac{1}{L} , and {γ}^{{n}_{1}} = \frac{1}{{L}_{max}}$$

is the minimum (cutoff) frequency which corresponds to the maximum asperity length-scale. The parameter γ determines the relative difference between the phases of participating waves in the superimposition that defines the multiscale rough surface. Random phases require the simulation of multiscale rough surfaces to have noncoincident phases of frequency modes. A value of γ=1.5 ensures such noncoincident random phases of frequency modes [27].

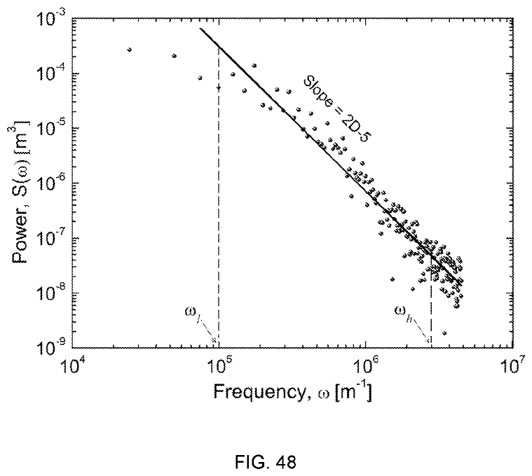

The power spectrum of the W-M function exhibits a power-law dependence on the spatial frequency, ω, given by:

$$S ( ω ) = \frac{{G}^{2 ( D - 1 )}}{2 ln ( γ )} \frac{1}{{ω}^{( 5 - 2 D )}} \qquad ( 2 )$$

where ω is the spatial frequency in units of m⁻¹. The power-law dependence of the power spectrum on the spatial frequency, ω, indicates the fractal nature of the W-M function. The fractal parameters of the textured surface can be obtained by a direct comparison between the power spectrum of the W-M function (Equation (2)) and the power spectrum of the textured surface profile (FIG. 48).

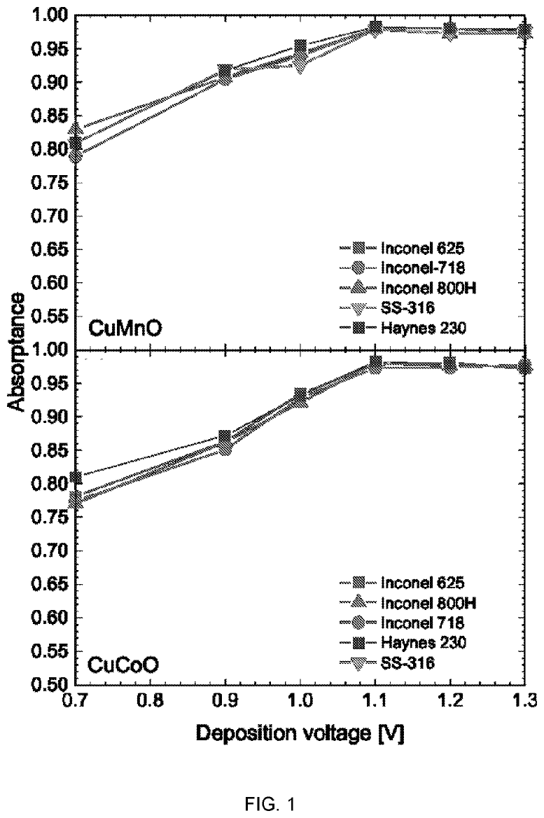

FIG. 48 shows one such power spectrum obtained based on the fast Fourier transform of a profilometric scan of the electrodeposited copper surface shown in FIG. 1d, where the wavelengths (spatial frequencies) contributing to the power spectrum of the surface profile lie between a minimum (ωₗ) and a maximum (ωₕ) value which are characteristic of the rough surface [21,22,28,29]. The lowest (ωₗ=10⁵ m⁻¹) and highest (ωₕ≈2.5×10⁵ m⁻¹) frequency values correspond to the maximum (Lₘₐₓ) and minimum (Lₘᵢₙ) length-scales of the asperities of a rough surface, respectively, such that

$${L}_{max} = \frac{1}{{ω}_{l}} and {L}_{min} = \frac{1}{{ω}_{h}} .$$

Further, a linear best fit curve on a log-log plot of the power spectrum (FIG. 48; R²=0.91), compared to the power spectrum of the W-M function, gives the characteristic fractal parameters of the rough surface. The slope of the linear best fit curve in the characteristic frequency range (ωₗ, ωₕ) determines the fractal dimension D such that the slope equals to (2D−5), and the intercept on the power axis is used to determine the scaling constant G. Therefore, a fractal representation of a rough surface, when compared with the W-M function, uniquely determines the characteristic fractal parameters (D, G, Lₘᵢₙ, Lₘₐₓ).

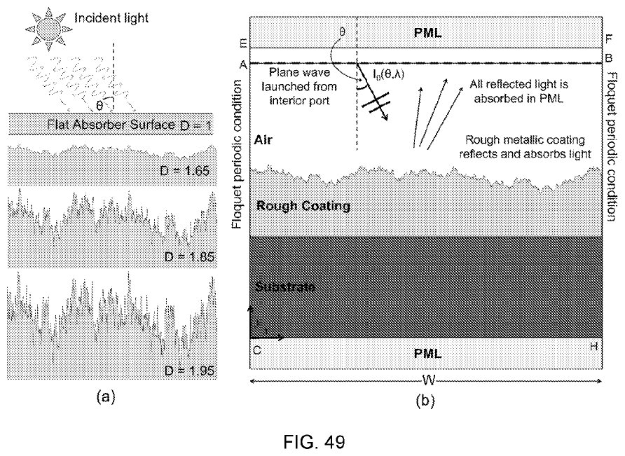

FIG. 49 represents the solar radiation reaching a plane surface, and a schematic representation of textured absorber surfaces described using the W-M function at three different fractal dimension values. Solar radiation (I₀) is incident on the rough coating surface, a part of which is reflected back to the ambient, and the remaining is transmitted or absorbed by the coating and the substrate. The coating reduces the reflection due to the multiscale micro-to nanostructured asperity structures, thereby absorbing more radiation for thermal conversion.

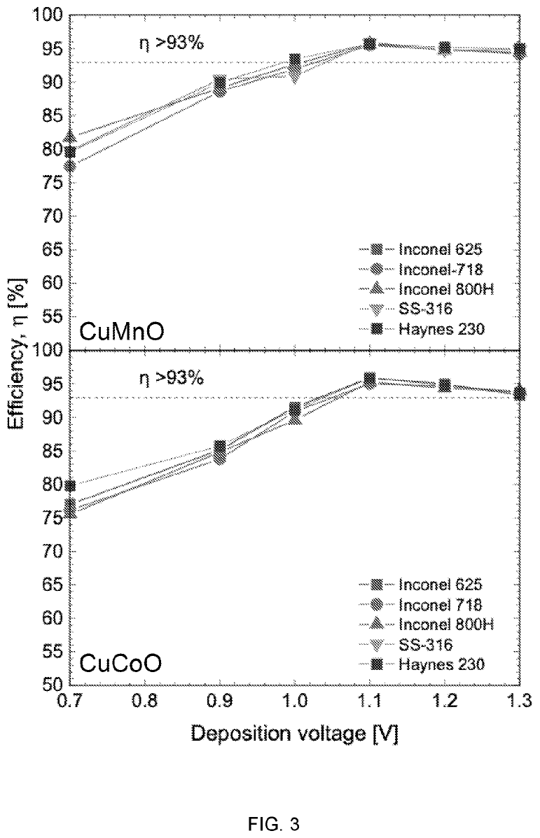

FIG. 49, panel b shows a schematic of the geometry and the domain considered in the optical modeling of the textured solar absorber surface based on the W-M function. The width (W) of the computational domain is considered to the three times of the Lₘₐₓ and the thickness of the coating is considered 3 μm based on the experimental characterization. The thickness of the substrate is considered twice the coating thickness for the simulation purpose. Light is launched from the interior port AB (dashed line) toward the material interface at a wavelength, λ, and at an angle, θ, and light reflected from the rough surface toward this port passes through the section AB and is absorbed in a top perfectly matched layer (PML). At the EF boundary in 3b, the power flux in the upward direction is integrated and normalized by the incident power of the incoming radiation I₀(λ, θ) to obtain the total reflectance. A boundary layer mesh at the EF boundary layer is introduced with a single layer of elements much smaller than the wavelength to determine the integral of the power flux more accurately. The PML absorbs both the propagating and evanescent components of the field, but since only the propagating component needs to be absorbed, the PMLs should be placed far enough away from the material interfaces, and the PML should be at least half a wavelength away from the material interfaces to satisfy this condition. In the present study, the distance of the PML layer is twice the maximum wavelength considered for the study. Below the solar absorber coating is the substrate alloy onto which the coating is applied, such that the model considers the optical interaction of both the coating as well as the substrate with solar radiation. For reducing the computational domain in the simulation, only a skin of the substrate of thickness equal to twice the coating thickness was considered. The PML below the substrate (FIG. 3b) absorbs all the radiation reaching the layer, thereby making the simulations valid for any realistic thickness of the substrate.

The electromagnetic theory is used to investigate the effect of surface morphology and surface roughness on material absorptivity since an optical wave is a form of electromagnetic wave that propagates according to Maxwell's equations, which can be expressed as:

$$∇ \times ( {μ}_{r}^{- 1} ∇ \times \vec{E} ) - {{k}_{0}^{2} ( n - ik )}^{2} \vec{E} = 0 \qquad ( 3 )$$

where \vec{E} represents the electric field, μᵣ is the relative magnetic permeability (taken to be unity, μᵣ=1), k₀ is the wavenumber of free space given by k₀=ω\sqrt{ε₀μ₀}=ω/c₀, in which c₀ is the speed of light in the vacuum, and ω=2πf=2πc/λ is defined by wavelength λ. The terms n and k are the real and imaginary parts of the refractive index, respectively. Spectral refractive index (n and k) for the coating materials Cu, CuO, CuMnO, and substrate material Inconel is taken from the literature [30-34].

Equation (3), subject to the boundary conditions and the incident radiation power, I₀(λ, θ), from the inlet port (AB), is solved for the complex electric field, E(x, y, λ, θ), from which the three-dimensional field is obtained in terms of the out-of-plane wave number k_{z} as:

$$E ( x , y , z , λ , θ ) = \tilde{E} ( x , y , z , λ , θ ) {e}^{{ik}_{z} z} \qquad ( 4 )$$

in which E(x, y, λ, θ) is the complex amplitude. The irradiance (power density) is obtained from the electric field using the relationship [35]:

$$I ( x , y , z , λ , θ ) = \frac{1}{2} n \sqrt{\frac{{ε}_{0}}{{μ}_{0}}} {\vert \vec{E} \vert}^{2} cos θ \qquad ( 5 )$$

in which ε₀ and μ₀ are the permittivity and permeability of free space, |\vec{E}| is the magnitude of the electric field, and θ is the incidence angle. The reflectance at the glass surface, R(λ, θ), can be calculated as the ratio of the power flow in the positive y-direction (reverse to the launch of the plane wave) to the base power I₀(λ, θ) at the boundary EF in FIG. 3b. The absorptance is then determined from the reflectance as α(λ, θ)=1−R(λ, θ). The spectral reflectance, R(λ), is obtained by integrating R(λ, θ) over θ. from which the spectral absorptance is determined as α(λ)=1−R(λ), and, likewise, by integrating R(λ, θ) with respect to λ over the relevant wavelength range and taking its 1's complement, the average absorptance variation with the incidence angle, α̅(θ), is obtained.

The governing partial differential equations subjected to the boundary conditions were solved using the Wave Optics, Electromagnetic Wave, and Frequency Domain modules of the commercial software COMSOL Multiphysics 5.5, based on the finite element method [36] software based on the finite element analysis technique. The computational domain was discretized appropriately, and the mesh size dependency was studied to determine the size based on accuracy and computation time. A mesh refinement study was conducted by progressively reducing the mesh size in the computation domain until decreasing the mesh element size further yielded no significant change in the results. The mesh element size was reduced near the coating boundary and air to minimize the error in the calculations. To guarantee the accuracy of the solution, the biggest mesh dimension is less than

$$\frac{{λ}_{0}}{6 n} ,$$

where λ₀ represents the incident light minimum wavelength, and n is the refractive index of the medium. The equations were solved in the electromagnetic wavelength domain with the wavelength sweep and stationary solver in COMSOL Multiphysics 5.5, having relative tolerance of 10⁻⁴.

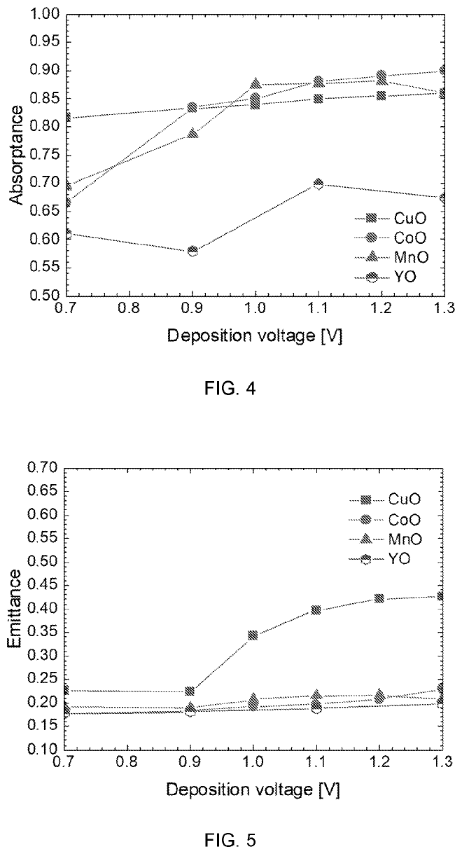

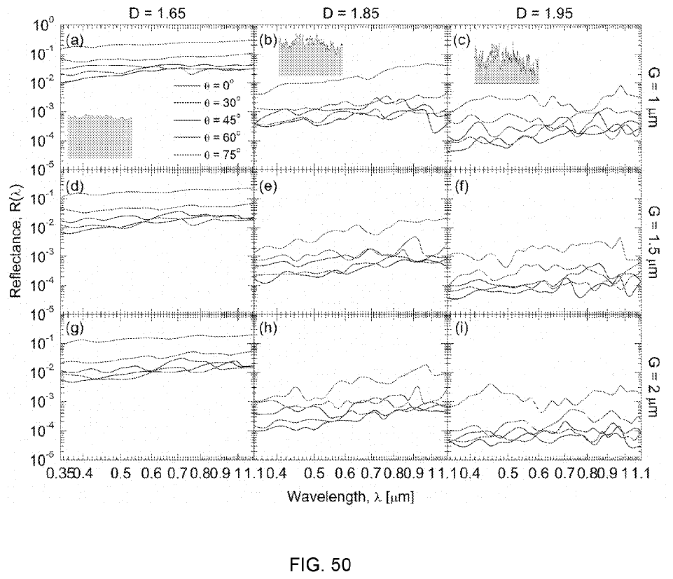

FIG. 50 provides an illustration of the breadth of fractal dimension D and scaling factor G. FIG. 50 presents the spectral variation of the reflectance of electrodeposited CuMnO coatings over wavelengths ranging from 350 nm to 1100 nm at different light incidence angles, θ=0° (normal incidence), 30°, 45°, 60°, and 75°, for nine combinations of fractal dimension, D, and scaling factor, G, of the W-M function. The reflectance of the absorber surface increases with an increase in the light incidence angle for all D and G values. An increase in the incidence angle corresponds to increasing deviation from normal incidence, thereby increasing the reflected component compared to the absorbed component of the radiation. In the limit of θ=90°, corresponding to grazing incidence, all the incident radiation is reflected regardless of wavelength for the reflectance of unity. The variation of the spectral reflectance profiles with an angle in FIG. 4 confirms this trend.

The effect of increasing fractal dimension D on the spectral reflectance is seen in the plot frames FIG. 50, panels (a-c), (d-f), and (g-i) going from left to right, in each of the three rows representing a different scaling factor G. An increase in the fractal dimension, D, denotes an increase in the surface roughness, which enhances light trapping in between the asperities. As a result, the reflectance over the fractal-textured absorber surface decreases. For an increase in fractal dimension from 1.65 to 1.95, the reflectance is seen to decrease by two orders of magnitude for all values of the scaling constant, G, and incidence angle, θ.

FIG. 50 further shows that the reflectance decreases with an increase in the scaling factor G, because the asperity height increases with G, which, in turn, enhances the light trapping. For the small D value, nearly linear trends are observed (FIG. 50, panels a, d, and g), and with an increase in the scaling factor G as well as D, the variation of spectral reflectance shows nonmonotonic variation with wavelength due to the interactions of the different wavelengths with the different asperity sizes. Compared to the effect of the fractal dimension, increasing the scaling factor offers a modest reduction in the reflectance by a factor of 2-4. Overall, FIG. 50 shows that the reflectance may be dramatically reduced by tailoring the fractal dimension and the scaling constant. For example, the reflectance values range from about 0.2 for D=1.65 and G=1 μm, and reduce to about 0.001 for =1.95 and G=2 μm. It is also important to observe that a two-order reduction in reflectance through absorber surface texturing is achieved for high incidence angles as well. The results point to significant opportunities for solar radiation capture over a wider range of incidence angles through fractal texturing.

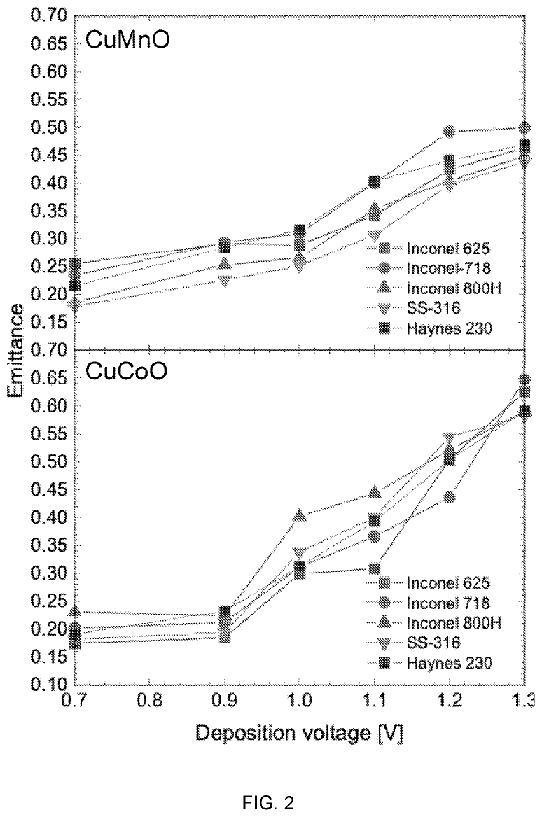

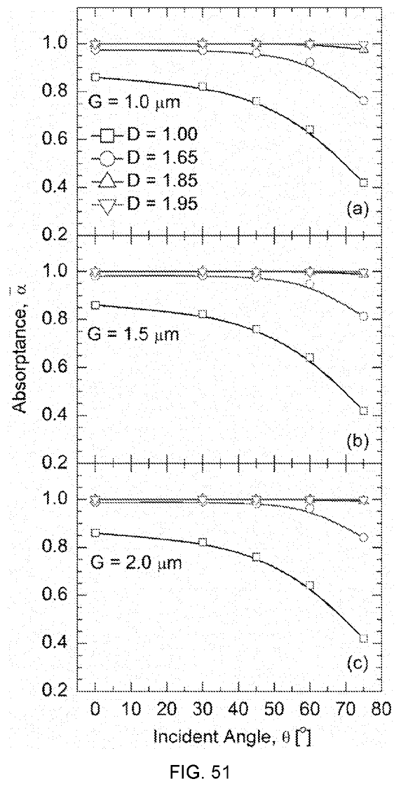

FIG. 51, panels a-c represents the variation of the spectrally averaged absorptance with incidence angle θ for absorber surfaces with different fractal dimensions D, and scaling constant, G=1 μm (FIG. 5a), 1.5 μm (FIGS. 5b) and 2 μm (FIG. 5c). The spectrally averaged absorptance was calculated by first spectrally averaging the reflectance profile to obtain R(θ), and then taking its 1's complement to obtain α̅(θ). For a given fractal surface, the absorptance is nearly unity for normal incidence of light (θ=0°) and decreases with an increase in θ; when the light wave is parallel to the surface (θ=90°), no component is absorbed by the surface. It is seen that with increasing fractal dimension from that of a plain surface, the absorptance increases significantly. Beyond a certain fractal dimension, D≈1.85 in FIG. 51, the absorptance value saturates as it is already near unity, as seen by the overlapping curves for D=1.85 and 1.95 for all G values. Further, it is noted from FIG. 5 that the absorptance is about 1 over a wide range of incident angles than the plain surface. This range increases with increasing fractal dimension, D, and/or the scaling constant, G. For example, the absorptance stays near 1 for θ<65° in FIG. 51 for D=1.85 and 1.95, whereas for the untextured surface (D=1), the decrease in absorptance is pronounced for all values of θ starting from 0°. Similarly, as G increases (for a given fractal dimension), the range of incidence angle over which the absorptance remains nearly constant increases. As an illustration, considering D=1.65, the incidence angle range extends till 47.5° for G=1 μm (FIG. 51, Panel a), 52.5° for G=1.5 μm (FIG. 51, Panel b), and 57.5° for G=2 μm (FIG. 51, Panel c)

Overall, FIG. 50 and FIG. 51 illustrations point to the significant benefits of fractal texturing in increasing solar energy absorption and, further, that the absorption characteristics can be tailored through appropriate texturing to obtain the desired fractal parameters.

### Substrate

The term substrate may mean any body which conducts electricity or may comprise a surface which conducts electricity. Suitable substrates include nearly any metal substrate, e.g., some 3d transition metals, (e.g., Co, Cu, Cr, Fe, Ni, Zn, etc.). Other suitable substrates include a stainless steel, e.g., an alloy, such as SS-316, SS 304, and the like. Other suitable substrates include high-nickel content alloys, such as Inconel 625, Inconel 800H, Inconel 718, Haynes 230, Hastelloy, Ha282, In740H, etc. Other alloys such as Monel, a Ni—Cr alloy, a Ni—Fe—Cr alloy are suitable substrates. In an aspect of the disclosure, and with reference to FIG. 1, FIG. 2, and FIG. 3, absorber coatings can be fabricated on any substrate with high absorber efficiency, and the process can be tailored according to the needs of the absorber.

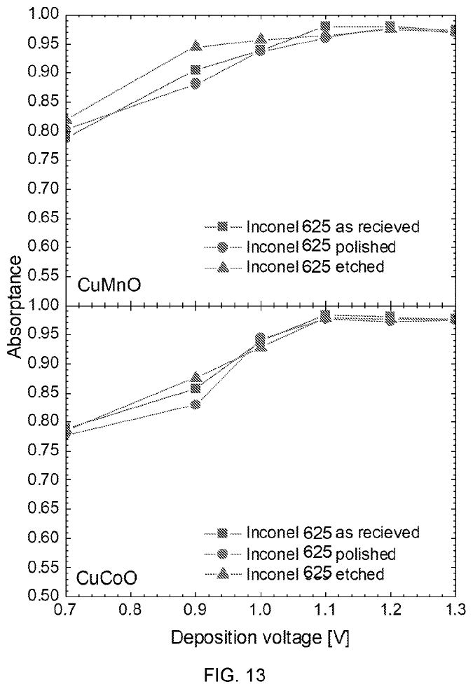

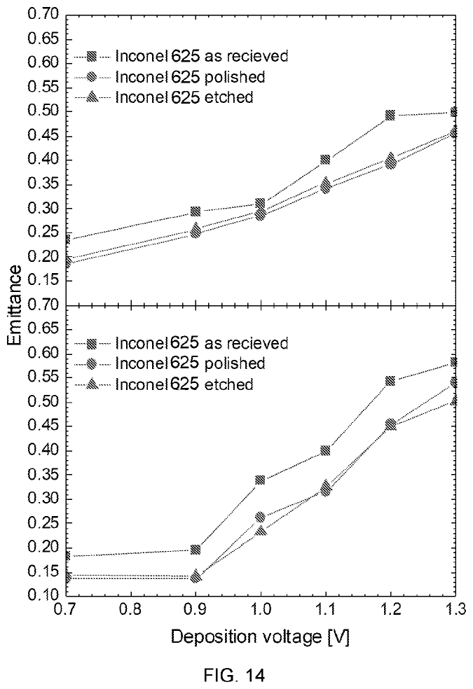

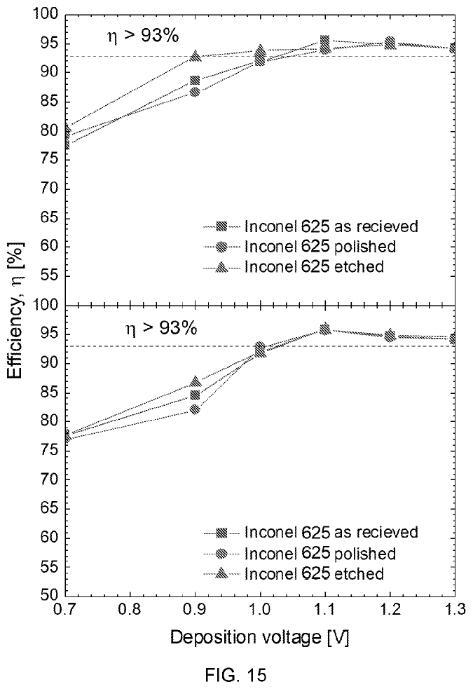

In an aspect of the disclosure, substrate may be independent of any pretreatment or surface conditioning. For example, with reference to FIG. 13-FIG. 15, solar efficiency is substantially unaffected by pretreating a surface onto which at least two metal oxide coatings are layered. Surface treatment or conditioning includes chemical etching, plasma etching, sanding, sandblasting, shot-peening, mechanical polishing, and electropolishing.

In an aspect of the disclosure, it was found that substrate finish does not affect absorptance of coatings deposited above 1.1 V voltages. In an aspect, emittance was favorably decreased for polished and etched substrates.

In an embodiment, the solar absorber material may be enhanced or tuned using an interlayer or overlayer. Absorber coatings can be deposited on any material with a conducting or semiconducting interlayer. An interlayer can include, but is not limited to: e.g., nickel, molybdenum, chromium, titanium, tungsten, any element(s) from the transition metal group of the Periodic Table, for example, indium tin oxide (ITO), etc. In an embodiment, an interlayer may prevent diffusion/migration of alloy elements from a base substrate to the coating thereby preventing optical property degradation.

Also in an embodiment, an overlayer such as SiO₂, TiO₂, Indium tin oxide (ITO), and the like can be deposited on an absorber material after preparation by any chemical methods such as, but not limited to, electrodeposition, sol-gel, dip coating, spray coating, chemical vapor deposition, etc. or by physical vapor method such as sputtering, thermal evaporation, ion beam evaporation, atomic layer deposition (ALD), etc. In an embodiment, an overlayer acts as a protective barrier; and, may have antireflective properties, together enhancing coating durability and optical properties.

As understood by a person of ordinary skill in the art, antireflective coatings may be added to the substrate and or coatings.

In an embodiment, the substrate may comprise a shaped surface. Absorber coatings can be deposited on different substrate shapes such as, but not limited to, flat substrates with any sizes, curved surfaces such as half cylinders, cylinders.

### Metal

In an aspect, electrodeposited metals are selected from the group consisting of 3d transition metals, however, this is not limiting. In general, the metals chromium, manganese, iron, cobalt, nickel, copper, zinc, yttrium, and aluminum may be electrodeposited.

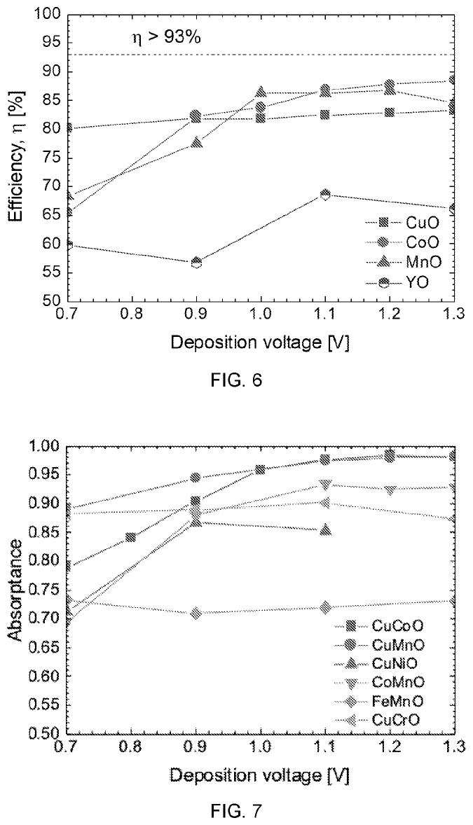

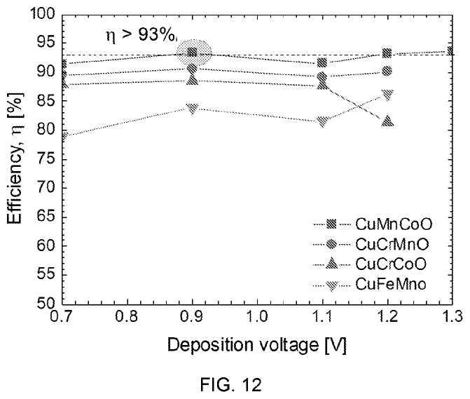

In an aspect, the number of metals deposited may be 2, 3, 4, 5, or 6. Generally 2, 3, or 4 metals may be deposited. In general, a single metal is not preferred as the desired absorptance, and efficiency, of the finished solar absorber are not as high as with 2 or 3 deposited metals. See FIG. 4 to FIG. 12.

### Annealed

The term annealed means heated at a defined temperature, for a defined period of time. In general, while not limiting, the substrate and metal layer prepared as a result of electrodeposition is heated from about 300 degrees to 1000 degrees C., for a time to fully develop a multiscaled fractal textured surface and to oxidize the formed multiscaled, textured surface to form a black absorber. In general, annealing takes place, at temperatures from 200 degrees C. to about 600 degrees C. for durations, of a few hours, nominally 2 hours.

### Properties of Solar Absorbers

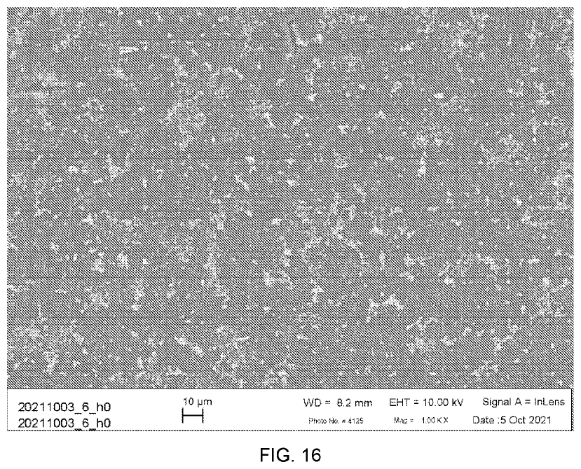

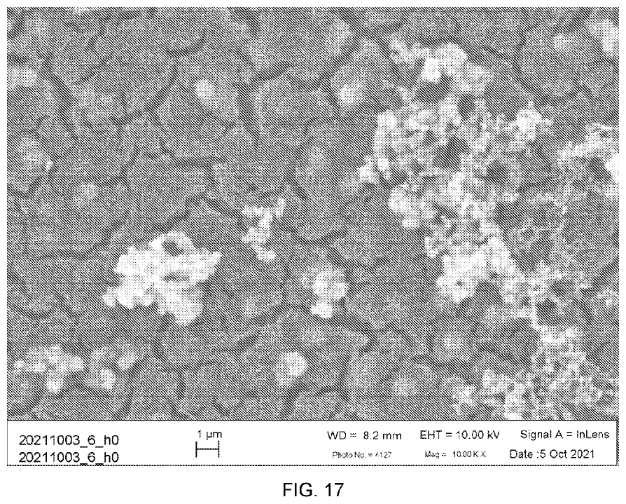

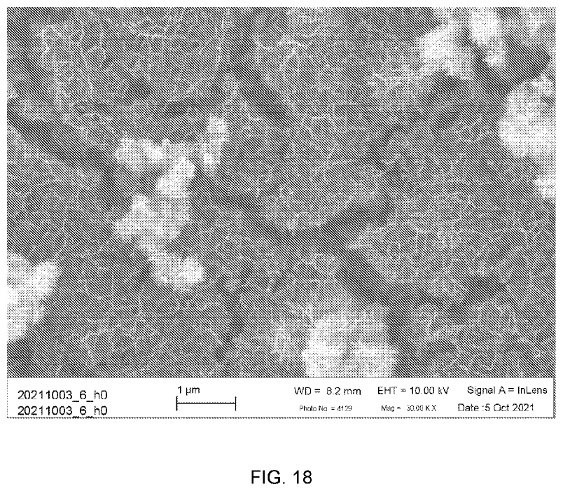

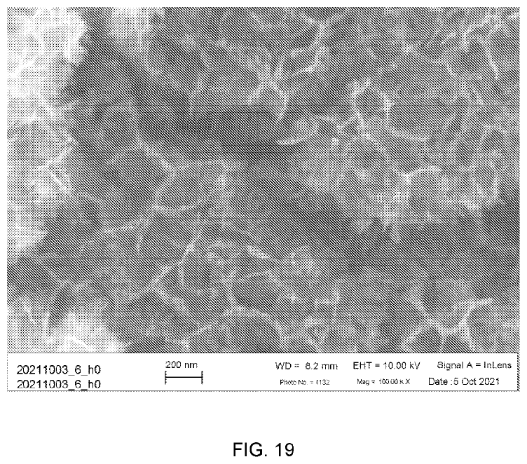

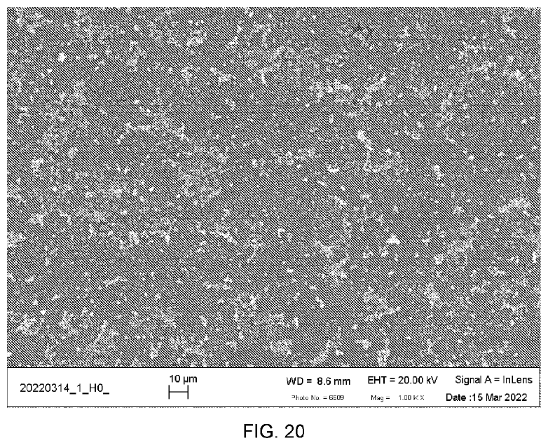

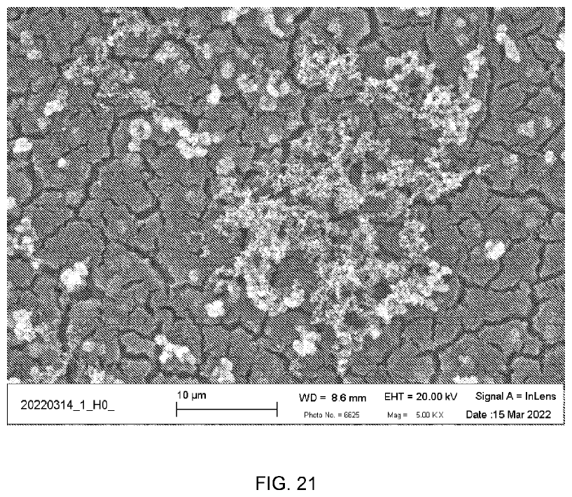

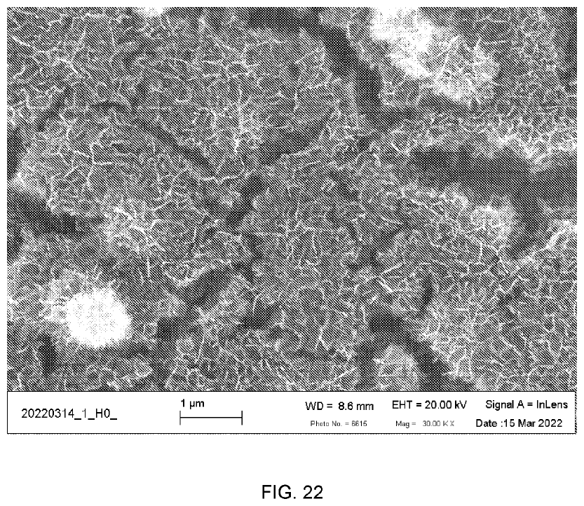

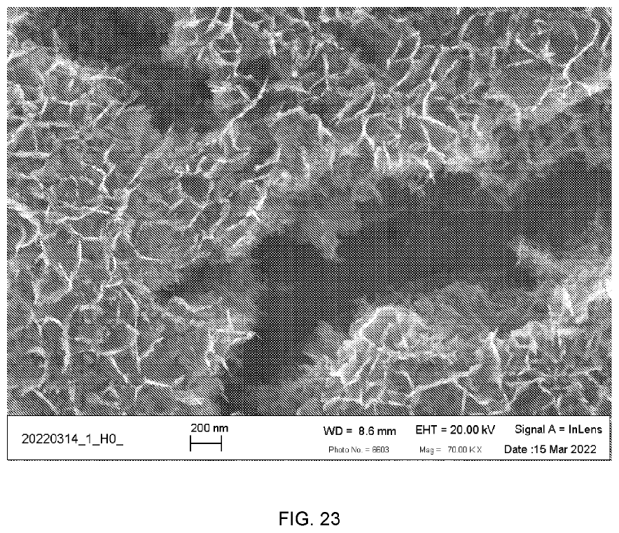

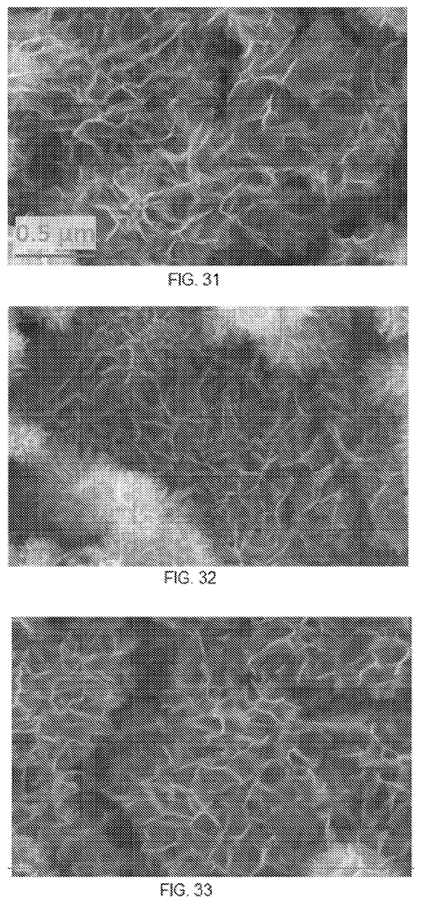

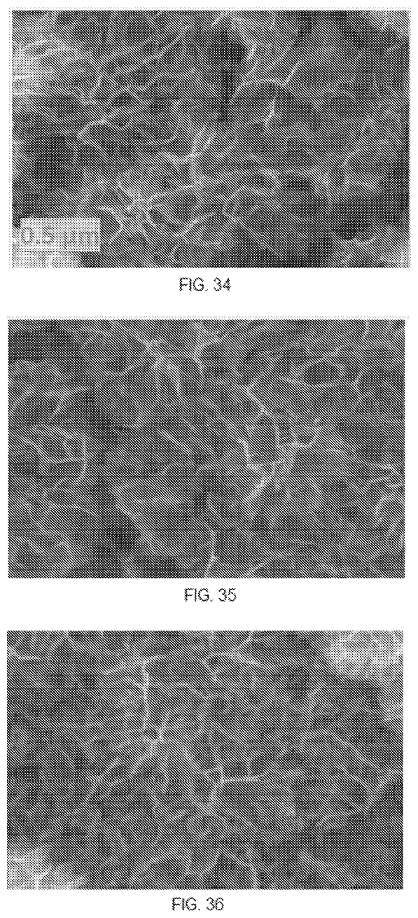

In an aspect ot the disclosure, absorptance spectra of 2 metal and 3 metal oxide coatings, e.g., CuMnO and CuCoO coatings deposited at various electrodeposition voltages, reveal that as the deposition voltage is increased, the optical absorptance increases for both CuMnO and CuCoO. As seen in FESEM images in FIGS. 16-23, these complex nanostructures with spacings of a few to a few hundreds of nanometers, generally may correspond with the wavelength of the visible spectrum and/or may absorb the in the ultraviolet to visible wavelength region of the solar spectrum. In an embodiment, the top web structures may trap visible light rays by multiple reflections and achieve the highest absorptance. In an embodiment, the high absorptance may be produced by a high degree of inner reflectivity or internal reflectance, once the light enters the nanostructure of the solar absorber. Such evidence is also shown in FIGS. 31-36.

### Dependence of Solar Absorber Properties on Deposition Conditions

As may be seen in the various figures, deposition voltage in the electrochemical cells is selectable to achieve optimized properties of absorptance and emittance, i.e., efficiency, of the solar absorber. In general, deposition voltage may be about 0.7, about 0.8, about 0.9, about 1.0, about 1.1, about 1.2, about 1.3, about 1.4, or about 1.5 V. In the foregoing array of numbers, the person of ordinary skill may see that the deposition voltage may be in a range from one number to another, for example from about 1.0 to about 1.2 V. Optimal absorptance may be achieved at about 1.1 V.

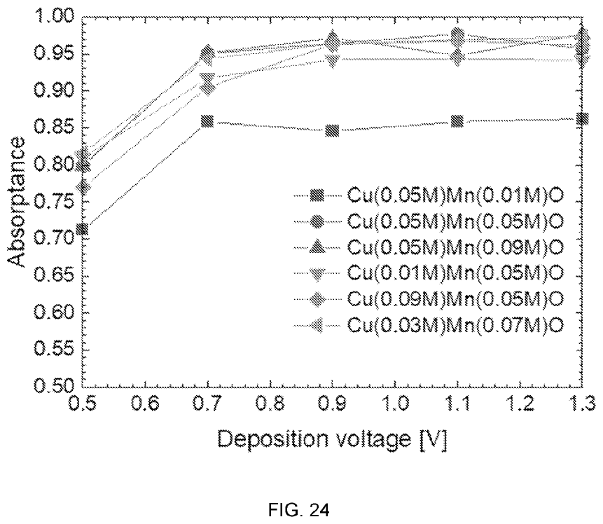

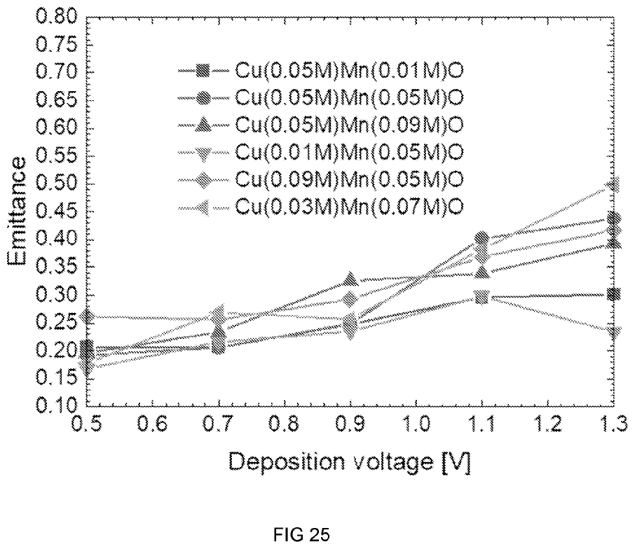

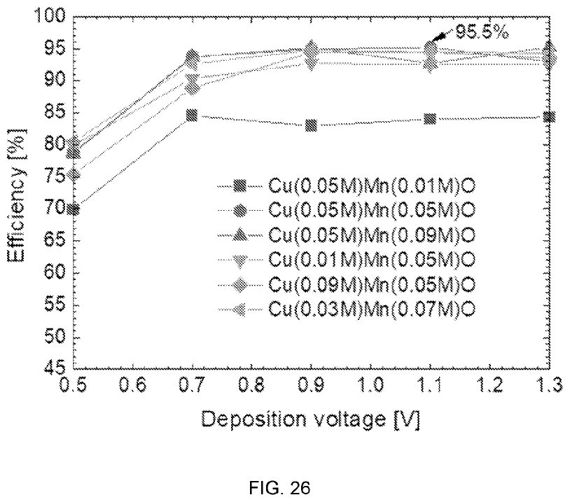

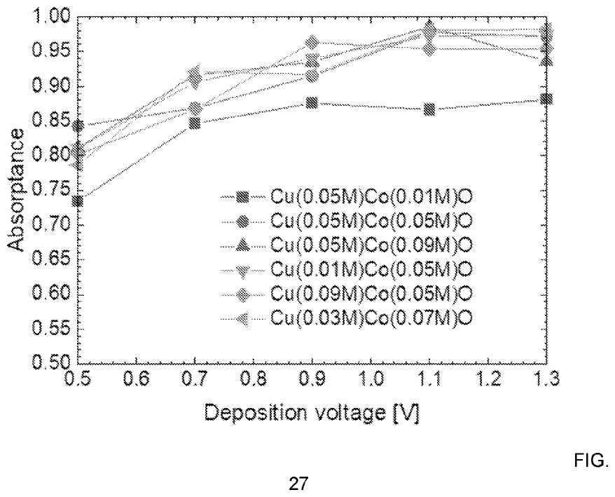

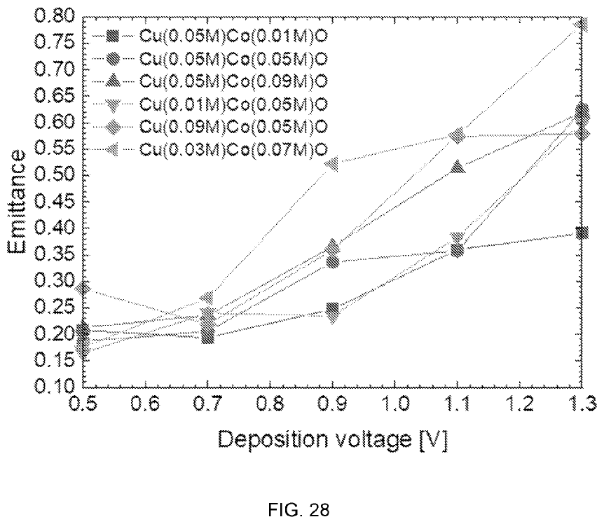

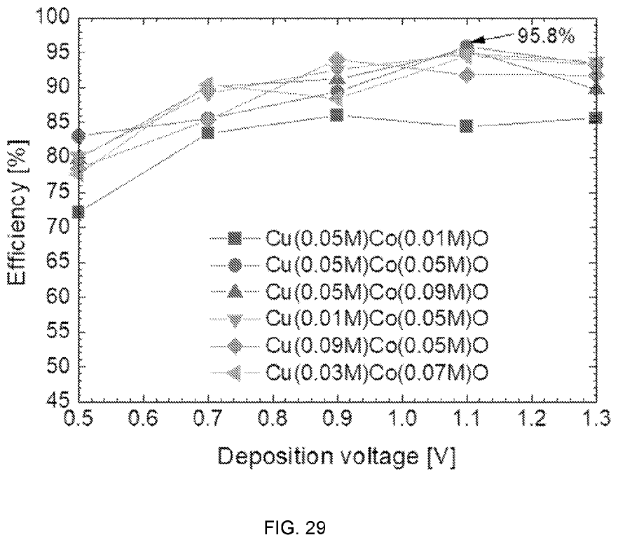

Generally, the concentration of one or more metal salts in the electrodeposition solution is about from 0.01 to about 0.1 M although the concentration range could be from lower than 0.01 molarity to higher than 0.1 molarity. However, it is generally understood that the concentration of salts is independent of absorber quality and properties, according to FIGS. 24-29.

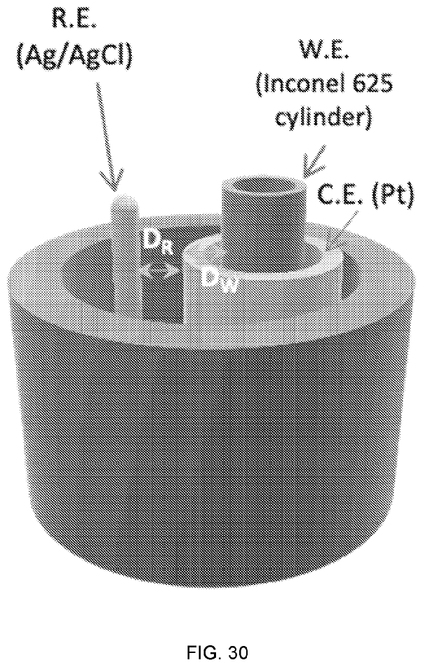

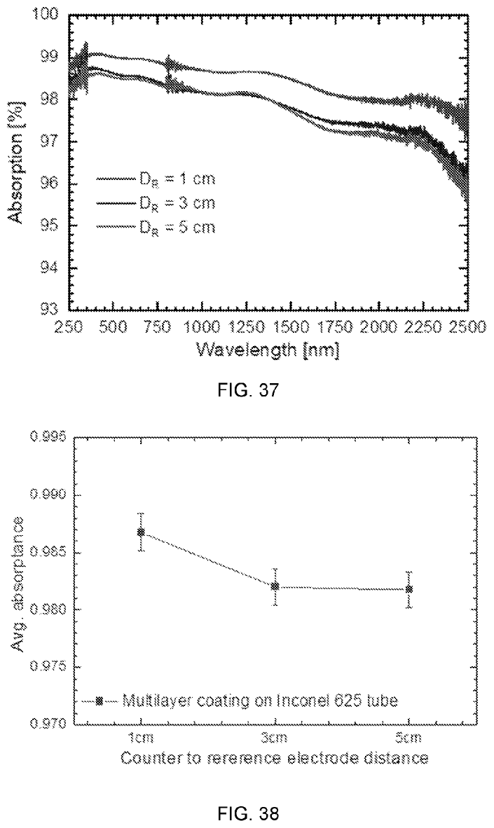

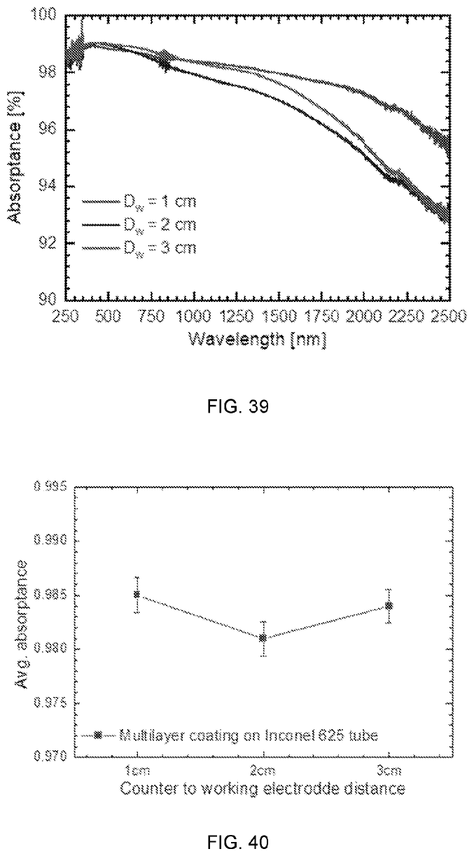

With reference to FIGS. 30-36, in another aspect of the disclosure, the electrodeposition is generally independent of any distance or physical configuration of the working electrode, counter electrode and/or reference electrode in contact with the aqueous solutions. For example, with respect to FIG. 30, in an aspect, the electrochemical cell comprises the working electrode (W.E) which is an Inconel 625 cylinder of outer diameter OD, a cylindrical platinum counter electrode (C.E.), the outer surface spaced at distance D_{w} from the OD; and a silver/silver chloride reference electrode (R.E.) wherein the R.E. is spaced at distance DR from the C.E. Variance of the D_{R} and D_{w} has generally little effect on the nature of the multiscaled textured metal oxide layers or on the coating as a whole (FIGS. 31-40). In an embodiment, as D_{R} and D_{w} are minimized and approach values of around a 0.5 to 1 cm, there is a slight (1, 2, 3, 4, 5, 6 or 7%) increase in absorptance of the absorber.

Generally, the anion of the metal salt is independent of absorber properties. In an embodiment, the metal salt is any Cu, Mn, Co, Cr, Fe, Ni, Y, and/or Al salt. For example, nitrate, sulfate, fluoride, chloride, bromide, and/or iodide salts are acceptable salts. The salt may be used as a hydrate or added in anhydrous form. Examples of appropriate salts include Cu(NO₃)₂.6H₂O, Mn(NO₃)₂.4H₂O, Co(NO₃)₂.6H₂O, Cr(NO₃)₃Fe(NO₃)₃ Nickel (II) nitrate hexahydrate, Yittrium nitrate, Al(NO3)3.9H2O, CuSO4, and others known to one of ordinary skill in the art.

### Solar Absorber Properties are Maintained under Various Physical Stresses

### Heat

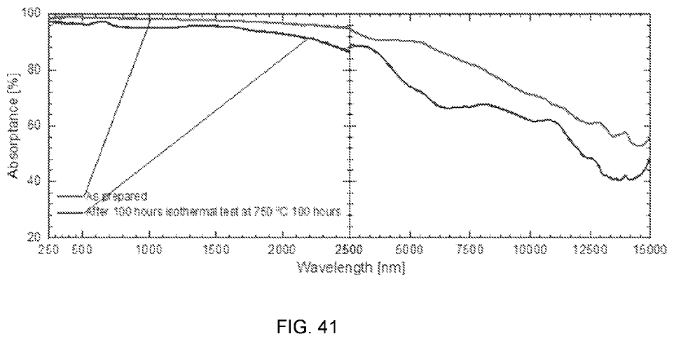

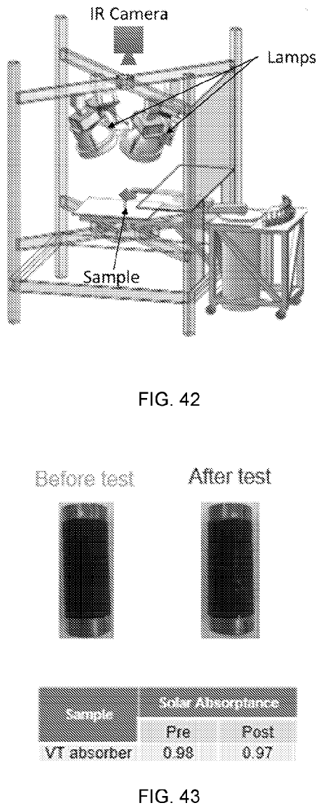

With respect to FIG. 41, the efficiency of the solar absorber after extremely harsh heat treatment, is unexpectedly exceptional. In a representative example, exposure of a CuNiO substrate to 750° C. for 100 hours in air caused a slight decrease of absorptance of in the visible spectrum, but with almost no decrease in the ultraviolet spectrum. In general, absorption may be decreased by about 1%, or about 2%, or about 3%, or about 4%, or about 5%, or about 6%, or about 7%, or about 8%, in the ultraviolet/visible (200-500 nm) spectrum; and/or there may be decrease of about 1%, or about 2%, or about 3%, or about 4%, or about 5%, or about 6%, or about 7%, or about 8%, or about 9%, or about 10% in the visible spectrum of from 500 to 1500 nm; and/or there may be decrease of about 1%, or about 2%, or about 3%, or about 4%, or about 5%, or about 6%, or about 7%, or about 8%, or about 9%, or about 10%, or about 11% or about 12%, or about 13% or about 14% or about 15% in the visible spectrum from about 1500 nm to about 2000 nm.

### Water Test

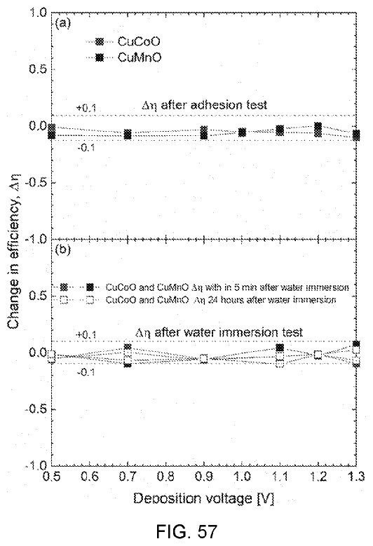

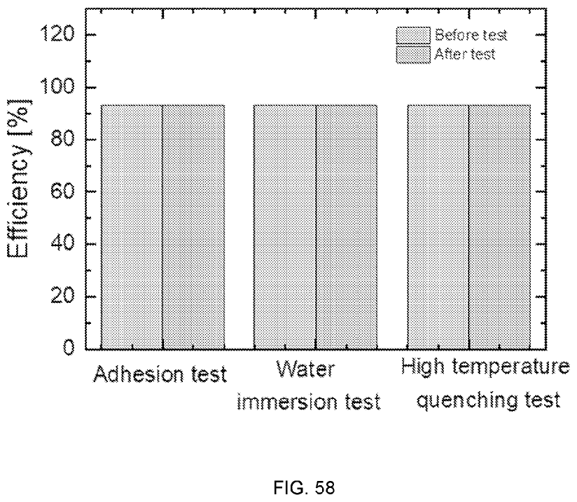

The solar absorbers are robust and water-resistant, according to the water test, described infra. The absorbers may be robust for weeks, months, and years under rainy and/or moisture conditions. See FIGS. 57-58—absorptance is substantially unaffected.

### Adhesion Test

The solar absorbers are robust and peel-resistant, according to the adhesion test, described infra. The absorbers may be robust for weeks, months, and years and not disintegrate due to mechanical roughening or scraping. See FIGS. 57-58—absorptance is substantially unaffected.

### High-Temperature Quenching Test

The solar absorbers are robust and resistant to thermal shock (e.g., a rainstorm), according to the Thermal Shock Test, described infra. The absorbers may be robust for weeks, months, and years and not disintegrate due to thermal shock. See FIGS. 57-58—absorptance is substantially unaffected.

### Irradiance Cycling

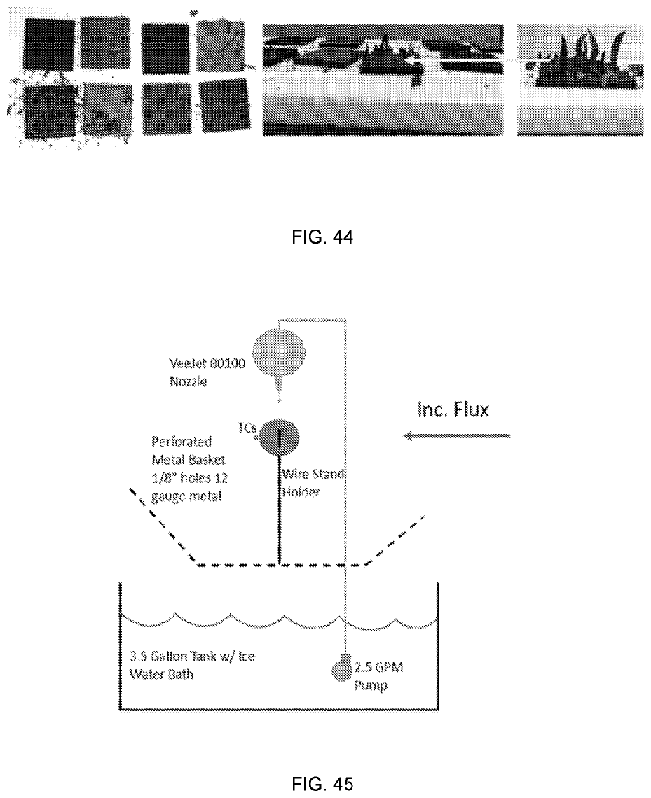

The solar absorbers are robust and resistant to repeated sunlight tests under extreme conditions (e.g., a rainstorm), according to the Irradiance Cycling Protocol, described infra. The absorbers may be robust for weeks, months, and years and not disintegrate due to thermal shock. See FIG. 43—absorptance is substantially unaffected, e.g., at most by 1-5%. For data on a commercially used absorber, Pyromark, see FIG. 44.

### Comparison of Solar Absorber to Industry Standards

Unexpectedly, the solar absorbers are superior to industry standards as represented by Table 1. In particular, the absorber has the highest efficiency of all and the least emittance of all even after being subject to harsh thermal treatment:

TABLE 1

| | Absorptance | | Emittance | | Efficiency [%] | |
|---|---|---|---|---|---|---|
| | | After | | After | | After |
| | | heating | | heating | | heating |
| | Pristine | at 750° C. | Pristine | at 750° C. | Pristine | at 750° C. |
| Pyromark 2500 [1] | 0.972 | 0.969 | 0.887 | 0.892 | 91.69 | 91.36 |
| Lab-IR HT [1] | 0.962 | 0.870 | 0.788 | 0.795 | 91.30 | 82.06 |
| Macota 3G-HT [1] | 0.948 | 0.833 | 0.748 | 0.749 | 90.15 | 78.65 |
| Glacier Black C- | 0.939 | 0.917 | 0.844 | 0.851 | 88.66 | 86.41 |
| 7600Q [1] | | | | | | |
| Senotherm | 0.939 | 0.850 | 0.711 | 0.705 | 89.48 | 80.62 |
| UHT600 [1] | | | | | | |
| Aremco HiE-Coat | 0.955 | 0.950 | 0.868 | 0.872 | 90.11 | 89.58 |
| M [1] | | | | | | |
| Aremco HiE-Coat | 0.943 | 0.940 | 0.853 | 0.855 | 88.99 | 88.69 |
| 840C [1] | | | | | | |
| Slovenia NIC, Black | 0.971 | 0.958 | 0.892 | 0.893 | 91.56 | 90.25 |
| 444 [1] | | | | | | |
| Coterill 750 [1] | 0.977 | 0.979 | 0.902 | 0.892 | 92.09 | 92.35 |
| CuFeMnO₄/ | — | — | — | — | 90.30 | 89.60 |
| CuCr₂O₄ [2] | | | | | | |
| MnFe2O4 [3] | 0.921 | 0.930 | 0.464 | | 89.2 | 89.70 |
| Cu_{0.15}Co_{2.84}O₄ [3] | | | | | 90.38 | 90.26 |
| Cu_{1.5}Mn_{1.5}O₄ [4] | | | | | 90.90 | 90.48 |
| Co₃O₄ [5] | | | | | 88.20 | 88.20 |
| Solar Absorber | 0.983 | 0.964 | 0.53 | 0.509 | 95 | 93.23 |

[1]. Caron et al., AIP Conference Proceedings 2303, 150007 (2020)
[2]. Kim et al., Solar Energy 132 (2016) 257-266
[3]. Karas et al., Solar Energy Materials and Solar Cells 182 (2018) 321-330
[4]. Lee et al., Proc. SPIE 10730. doi: 10.1117/12.2319957
[5]. Harzallah et al., AIP Conference Proceedings 2126, 030026 (2019)

In an embodiment, the emittance of the solar absorber of the present disclosure is significantly lower than industry standards—both pristine and after significant heating at 750° C., which indicates that the overall efficiency of the solar absorber is orders of magnitude more efficient than industry standards.

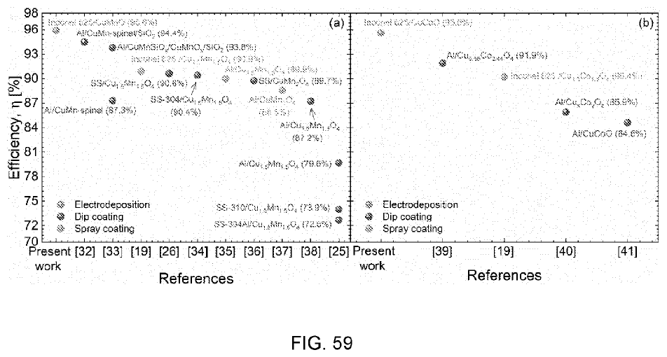

In an embodiment, and with reference to FIG. 59, the overall superiority of the solar absorbers of the present disclosure o

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### REFERENCES

References are cited herein throughout using the format of reference number(s) enclosed by parentheses corresponding to one or more of the following numbered references.
1] M. Caccia, M. Tabandeh-Khorshid, G. Itskos, A. R. Strayer, A. S. Caldwell, S. Pidaparti, S. Singnisai, A. D. Rohskopf, A. M. Schroeder, D. Jarrahbashi, T. Kang, S. Sahoo, N. R. Kadasala, A. Marquez-Rossy, M. H. Anderson, E. Lara-Curzio, D. Ranjan, A. Henry, K. H. Sandhage, Ceramic-metal composites for heat exchangers in concentrated solar power plants, Nature. 562 (2018) 406-409. https://doi.org/10.1038/s41586-018-0593-1.
[2] L. Huaxu, W. Fuqiang, Z. Dong, C. Ziming, Z. Chuanxin, L. Bo, X. Huijin, Experimental investigation of cost-effective ZnO nanofluid based spectral splitting CPV/T system, Energy. 194 (2020) 116913. https://doi.org/10.1016/j.energy.2020.116913.
[3] R. Pitz-Paal, Concentrating solar power: Still small but learning fast, Nature Energy. 2 (2017) 17095. https://doi.org/10.1038/nenergy.2017.95.
[4] G. Schellekens, A. Battaglini, J. Lilliestam, J. McDonnell, A. Patt, 100% renewable electricity: A roadmap to 2050 for Europe and North Africa, PricewaterhouseCoopers. (2010). http://pure.iiasa.ac.at/id/eprint/9383/.
[5] M. M. Hand, S. Baldwin, E. DeMeo, J. M. Reilly, T. Mai, D. Arent, G. Porro, M. Meshek, D. Sandor, Renewable electricity futures study. volume 1. exploration of high-penetration renewable electricity futures, National Renewable Energy Lab. (NREL), Golden, CO (United States); (2012).
[6] R. Sioshansi, P. Denholm, The Value of Concentrating Solar Power and Thermal Energy Storage, IEEE Transactions on Sustainable Energy. 1 (2010) 173-183. https://doi.org/10.1109/TSTE.2010.2052078.
[7] K. Nithyanandam, R. Pitchumani, Cost and performance analysis of concentrating solar power systems with integrated latent thermal energy storage, Energy. 64 (2014) 793-810. https://doi.org/10.1016/j.energy.2013.10.095.
[8] K. Kant, P. H. Biwole, I. Shamseddine, G. Tlaiji, F. Pennec, F. Fardoun, Recent advances in thermophysical properties enhancement of phase change materials for thermal energy storage, Solar Energy Materials and Solar Cells. 231 (2021) 111309. https://doi.org/10.1016/j.solmat.2021.111309.
[9] R. Jain, R. Pitchumani, Fabrication and characterization of multiscale, fractal textured solar selective coatings, Solar Energy Materials and Solar Cells. 172 (2017) 213-219. https://doi.org/10.1016/j.solmat.2017.07.009.
[10] A. Cuevas, L. Martínez, R. Romero, E. A. Dalchiele, R. Marotti, D. Leinen, J. R. Ramos-Barrado, F. Martin, Electrochemically grown cobalt-alumina composite layer for solar thermal selective absorbers, Solar Energy Materials and Solar Cells. 130 (2014) 380-386. https://doi.org/10.1016/j.solmat.2014.07.041.
[11] T. K. Kim, B. VanSaders, J. Moon, T. Kim, C.-H. Liu, J. Khamwannah, D. Chun, D. Choi, A. Kargar, R. Chen, Z. Liu, S. Jin, Tandem structured spectrally selective coating layer of copper oxide nanowires combined with cobalt oxide nanoparticles, Nano Energy. 11 (2015) 247-259. https://doi.org/10.1016/j.nanoen.2014.10.018.
[12] A. Antonaia, A. Castaldo, M. L. Addonizio, S. Esposito, Stability of W-Al2O3 cermet based solar coating for receiver tube operating at high temperature, Solar Energy Materials and Solar Cells. 94 (2010) 1604-1611. https://doi.org/10.1016/j.solmat.2010.04.080.
[13] O. Raccurt, A. Disdier, D. Bourdon, S. Donnola, A. Stollo, A. Gioconia, Study of the Stability of a Selective Solar Absorber Coating under Air and High Temperature Conditions, Energy Procedia. 69 (2015) 1551-1557. https://doi.org/10.1016/j.egypro.2015.03.107.
[14] E. Barrera, F. Gonzalez, E. Rodriguez, J. Alvarez-Ramirez, Correlation of optical properties with the fractal microstructure of black molybdenum coatings, Applied Surface Science. 256 (2010) 1756-1763. https://doi.org/10.1016/j.apsusc.2009.09.108.
[15] M. Farooq, Z. H. Lee, Computations of the optical properties of metal/insulator-composites for solar selective absorbers, Renewable Energy. 28 (2003) 1421-1431. https://doi.org/10.1016/S0960-1481(02)00033-2.
[16] K. Xu, M. Du, L. Hao, J. Mi, Q. Yu, S. Li, A review of high-temperature selective absorbing coatings for solar thermal applications, Journal of Materiomics. 6 (2020) 167-182. https://doi.org/10.1016/j.jmat.2019.12.012.
[17] S. Pratesi, M. De Lucia, M. Meucci, E. Sani, Structural and optical properties of copper-coated substrates for solar thermal absorbers, Superlattices and Microstructures. 98 (2016) 342-350. https://doi.org/10.1016/j.spmi.2016.08.031.
[18] R. L. Axelbaum, H. Brandt, The effect of substrate surface preparation on the optical properties of a black chrome solar absorber coating, Solar Energy. 39 (1987) 233-241. https://doi.org/10.1016/S0038-092X(87)80032-4.
[19] P. Kowalczewski, M. Liscidini, L. C. Andreani, Engineering Gaussian disorder at rough interfaces for light trapping in thin-film solar cells, Optics Letters. 37 (2012) 4868. https://doi.org/10.1364/OL.37.004868.
[20] A. Majumdar, B. Bhushan, Role of Fractal Geometry in Roughness Characterization and Contact Mechanics of Surfaces, Journal of Tribology. 112 (1990) 205-216. https://doi.org/10.1115/1.2920243.
[21] A. Majumdar, B. Bhushan, Fractal Model of Elastic-Plastic Contact Between Rough Surfaces, Journal of Tribology. 113 (1991) 1-11. https://doi.org/10.1115/1.2920588.
[22] F. Yang, R. Pitchumani, Interlaminar contact development during thermoplastic fusion bonding, Polymer Engineering & Science. 42 (2002) 424-438. https://doi.org/10.1002/pen.10960.
[23] Yu Bing-Xi, Zheng Na, Liang Zhong-Zhu, Li Ya-Nan, Liang Jing-Qiu, Fang Wei, Wang Wei-Biao, Design and preparation of black-nickel film on the radiometer chip, Acta Physica Sinica. 59 (2010) 4530. https://doi.org/10.7498/aps.59.4530.
[24] Su Fa-Gang, Liang Jing-Qiu, Liang Zhong-Zhu, Zhu Wan-Bin, Study on the surface morphology and absorptivity of light-absorbing materials, Acta Physica Sinica. 60 (2011) 057802. https://doi.org/10.7498/aps.60.057802.
[25] C. Niu, T. Zhu, Y. Lv, Influence of Surface Morphology on Absorptivity of Light-Absorbing Materials, International Journal of Photoenergy. 2019 (2019) 1-9. https://doi.org/10.1155/2019/1476217.
[26] M. C. Kang, J. S. Kim, K. H. Kim, Fractal dimension analysis of machined surface depending on coated tool wear, Surface and Coatings Technology. 193 (2005) 259-265. https://doi.org/10.1016/j.surfcoat.2004.07.020.
[27] S. Hatte, R. Pitchumani, Fractal Model for Drag Reduction on Multiscale Nonwetting Rough Surfaces, Langmuir. 36 (2020) 14386-14402. https://doi.org/10.1021/acs.langmuir.0c02790.
[28] R. Jain, R. Pitchumani, Fractal Model for Wettability of Rough Surfaces, Langmuir. 33 (2017) 7181-7190. https://doi.org/10.1021/acs.langmuir.7b01524.
[29] F. M. Borodich, A. B. Mosolov, Fractal roughness in contact problems, Journal of Applied Mathematics and Mechanics. 56 (1992) 681-690. https://doi.org/10.1016/0021-8928(92)90054-C.
[30] H. Wieder, A. W. Czanderna, Optical Properties of Copper Oxide Films, Journal of Applied Physics. 37 (1966) 184-187. https://doi.org/10.1063/1.1707803.
[31] N. Özer, F. Tepehan, Structure and optical properties of electrochromic copper oxide films prepared by reactive and conventional evaporation techniques, Solar Energy Materials and Solar Cells. 30 (1993) 13-26. https://doi.org/10.1016/0927-0248(93)90027-Z.
[32] N. R. Dhineshbabu, V. Rajendran, N. Nithyavathy, R. Vetumperumal, Study of structural and optical properties of cupric oxide nanoparticles, Applied Nanoscience. 6 (2016) 933-939. https://doi.org/10.1007/s13204-015-0499-2.
[33] S. S. Falahatgar, F. E. Ghodsi, F. Z. Tepehan, G. G. Tepehan, İ. Turhan, Electrochromic performance, wettability and optical study of copper manganese oxide thin films: Effect of annealing temperature, Applied Surface Science. 289 (2014) 289-299. https://doi.org/10.1016/j.apsusc.2013.10.153.
[34] W. V. Goodell, J. K. Coulter, P. B. Johnson, Optical constants of Inconel alloy films, Journal of the Optical Society of America. 63 (1973) 185. https://doi.org/10.1364/JOSA.63.000185.
[35] S. S. Aćimović, Setting excitation in 3D, Optical Proprties of Graphene. (2022). http://srdjancomsol.weebly.com/setting-excitation-in-3d.html (accessed Jun. 24, 2022).
[36] COMSOL, Comsol, COMSOL Multiphysics User's Guide. (2020). http://www.comsol.com. (accessed Mar. 13, 2021).
[37] A. Haghdoost, R. Pitchumani, M. Kargar, Fabricating Porous Metallic Coatings Via Electrodeposition and Compositions Thereof, US20210309870A1 (Pending), 2021. https://patents.google.com/patent/US20210309870A1.
[38] R. Pitchumani, S. K. Purayil, Fractal Textured High Efficiency Solar Absorber Coatings, U.S. Provisional Patent No. 63/329,842., 2022.
[39] A. Haghdoost, R. Pitchumani, Fabricating Superhydrophobic Surfaces via a Two-Step Electrodeposition Technique, Langmuir. 30 (2014) 4183-4191. https://doi.org/10.1021/la403509d.
[40] Gwyddion, Gwyddion—Free SPM (AFM, SNOM/NSOM, STM, MFM, . . . ) data analysis software, (2021). http://gwyddion.net/(accessed Jan. 21, 2022).
[41] A. D. Rakić, A. B. Djurišić, J. M. Elazar, M. L. Majewski, Optical properties of metallic films for vertical-cavity optoelectronic devices, Applied Optics. 37 (1998) 5271. https://doi.org/10.1364/AO.37.005271.
[42] N. Özer, F. Tepehan, Structure and optical properties of electrochromic copper oxide films prepared by reactive and conventional evaporation techniques, Solar Energy Materials and Solar Cells. 30 (1993) 13-26. https://doi.org/10.1016/0927-0248(93)90027-Z.
[43] C. K. Ho, A. R. Mahoney, A. Ambrosini, M. Bencomo, A. Hall, T. N. Lambert, Characterization of Pyromark 2500 Paint for High-Temperature Solar Receivers, Journal of Solar Energy Engineering. 136 (2014). https://doi.org/10.1115/1.4024031.
[44] J. F. Torres, K. Tsuda, Y. Murakami, Y. Guo, S. Hosseini, C.-A. Asselineau, M. Taheri, K. Drewes, A. Tricoli, W. Lipiński, J. Coventry, Highly efficient and durable solar thermal energy harvesting via scalable hierarchical coatings inspired by stony corals, Energy & Environmental Science. 15 (2022) 1893-1906. https://doi.org/10.1039/D1EE03028K.

### ASPECTS

The disclosure will be better understood by reading the following numbered aspects, which should not be confused with the claims. In some instances, one or more aspects may be combined or combined with aspects or embodiments described elsewhere in the disclosure or aspects from the examples without deviating from the invention. The following listing of exemplary aspects supports and is supported by the disclosure provided.

Aspect 1. A solar absorbing material comprising: a substrate and an annealed coating overlying the substrate comprising an electrodeposited metal oxide layer comprising two metals selected from the group consisting of cobalt (Co), copper (Cu), chromium (Cr), iron (Fe), manganese (Mn), and nickel (Ni), on a surface of the substrate, wherein the metal oxide layer is a light-absorbing multiscale fractal textured surface, and wherein the efficiency of the solar absorbing material is from 90% to 99%.

Aspect 2. The solar absorbing material of Aspect 1 wherein the electrodeposited metal oxide layer comprises three metals.

Aspect 3. The solar absorbing material of Aspect 1 or Aspect 2 wherein the coating comprises two electrodeposited metal oxide layers.

Aspect 4. The solar absorbing material of any one of the foregoing Aspects wherein the coating comprises three electrodeposited metal oxide layers.

Aspect 5. The solar absorbing material of any one of the foregoing Aspects wherein the efficiency reduced by from about 1% to about 10% after a period of time of exposure to 750° C. in air at atmospheric pressure.

Aspect 6. The solar absorbing material of any one of the foregoing Aspects wherein the solar efficiency is reduced by from about 1% to about 10% after exposure to ultraviolet radiation as measured by the Absorber Cycling Protocol.

Aspect 7. The solar absorbing material of any one of the foregoing Aspects wherein the solar efficiency is reduced by from about 1% to about 10% by thermal shock as measured by the Water Quenching Test.

Aspect 8. The solar absorbing material of any one of the foregoing Aspects wherein the solar efficiency is reduced by from about 1% to about 10% as an angle of incidence of light on the solar-absorbing material is reduced from 65 deg to 10 deg relative to a plane in non-intersecting coincidence to the surface.

Aspect 9. The solar absorbing material of any one of the foregoing Aspects wherein the metals are selected from the group consisting of cobalt (Co), copper (Cu), nickel (Ni) and manganese (Mn).

Aspect 10. The solar absorbing material of any one of the foregoing Aspects wherein the metals are selected from the group consisting of Cu and Co.

Aspect 11. The solar absorbing material of any one of the foregoing Aspects wherein the metals are selected from the group consisting of Cu and Mn.

Aspect 12. The solar absorbing material of any one of the foregoing Aspects wherein the metal oxide coating has a thickness on the surface of the substrate from about 1 micron, about 2 micron, about 2.5 micron, about 3 micron and up to about 2.5 micron, about 3 micron, about 3.5 micron, about 4 micron, or more.

Aspect 13. The solar absorbing material of any one of the foregoing Aspects, wherein the substrate comprises a conductive metal substrate.

Aspect 14. The solar absorbing material of any one of the foregoing Aspects, wherein the material has an absorptance of at least 0.91, 0.92, 0.93, 0.94, 0.95, 0.96, 0.97, 0.98, 0.99, or more.

Aspect 15. The solar absorbing material of any one of the foregoing Aspects wherein the material has an emittance of about 0.55, 0.54, 0.53, 0.50, 0.45, 0.40, 0.35, 0.30, 0.25, or less.

Aspect 16. The solar absorbing material of any one of the foregoing Aspects wherein the substrate comprises one or more elements selected from the group consisting of chromium, manganese, iron, cobalt, nickel, copper, and zinc.

Aspect 17. The solar absorbing material of any one of the foregoing Aspects wherein the substrate is a steel.

Aspect 18. The solar absorbing material of any one of the foregoing Aspects wherein the substrate a stainless steel.

Aspect 19. The solar absorbing material of any one of the foregoing Aspects wherein the substrate is an alloy or steel comprising nickel from about 3% to about 50% by weight.

Aspect 20. A method of making the solar absorbing material of any one of the foregoing Aspects the method comprising: contacting the substrate with an aqueous solution comprising dissolved salts of two or more metals, wherein the aqueous solution is in contact with a first counter electrode, a working electrode, and a reference electrode; and applying a first voltage across the working electrode and counter electrode for a first period of time sufficient to deposit a first metal layer on the substrate, wherein the first metal layer comprises the two or more metals.

Aspect 21. The method of Aspect 20 further comprising contacting the substrate with a second aqueous solution comprising dissolved salts of two or more metals, wherein the second aqueous solution is in contact with a second counter electrode, a second working electrode, and a second reference electrode; and applying a second voltage across the second working electrode and second counter electrode for a second period of time sufficient to deposit a second metal layer on the substrate, wherein the second metal layer comprises the two or more metals, wherein the salts of the two or more metals in the second aqueous solution may be different from the salts of the two or more metals in the aqueous solution.

Aspect 22. The method of Aspect 21 or 22 further comprising contacting the substrate with a third aqueous solution comprising dissolved salts of two or more metals, wherein the third aqueous solution is in contact with a third counter electrode, a third working electrode, and a third reference electrode; and applying a third voltage across the third working electrode and third counter electrode for a third period of time sufficient to deposit a third metal layer on the substrate, wherein the third metal layer comprises the two or more metals, wherein the salts of the two or more metals in the third aqueous solution may be different from the salts of the two or more metals in the aqueous solution or from the salts of the two or more metals in the second aqueous solution.

Aspect 23. The method of any one of Aspects 20-22 wherein the second period of time is shorter than the first period of time.

Aspect 24. The method of any one of Aspects 20-23 wherein the third period of time is shorter than the second period of time.

Aspect 25. The method of any one of Aspects 20-24 wherein the second voltage is smaller than the first voltage.

Aspect 26. The method of any one of Aspects 20-25 wherein the third voltage is smaller than the second voltage.

Aspect 27. The method according to any one of Aspects 20-26 wherein the first voltage is about 0.5V to about 1.5 V, about 0.5 V to about 1 V, about 1 V to about 1.5 V, about 0.7 V to about 1.3 V, about 0.7 V to about 0.9 V, or about 0.9 V to about 1.3 V.

Aspect 28. The method according to any one of Aspects 20-27 wherein the second voltage is about 0.5V to about 1.5 V, about 0.5 V to about 1 V, about 1 V to about 1.5 V, about 0.7 V to about 1.3 V, about 0.7 V to about 0.9 V, or about 0.9 V to about 1.3 V.

Aspect 29. The method according to any one of Aspects 20-28 wherein the third voltage is about 0.5V to about 1.5 V, about 0.5 V to about 1 V, about 1 V to about 1.5 V, about 0.7 V to about 1.3 V, about 0.7 V to about 0.9 V, or about 0.9 V to about 1.3 V.

Aspect 30. The method according to any one of Aspects 20-29, wherein the first period of time is from about 10 seconds, about 30 seconds, or about 60 seconds, about 90 seconds, about 120 seconds, about 180 seconds, about 240 seconds, or about 300 seconds.

Aspect 31. The method according to any one of Aspects 20-30, wherein the second period of time is from about 10 seconds, about 30 seconds, or about 60 seconds, about 90 seconds, about 120 seconds, about 180 seconds, about 240 seconds, or about 300 seconds.

Aspect 32. The method according to any one of Aspects 20-31, wherein the third period of time is from about 10 seconds, about 30 seconds, or about 60 seconds, about 90 seconds, about 120 seconds, about 180 seconds, about 240 seconds, or about 300 seconds.

Aspect 33. The method according to any one of Aspects 20-32, wherein the one or more dissolved metal salts are independently selected from copper salts, cobalt salts, manganese salts, iron salts, chromium salts, potassium salts, and a combination thereof.

Aspect 34. The method according to any one of Aspects 20-33, wherein one or both of the first solution and the second solution comprising an aqueous solution.

Aspect 35. The method according to any one of Aspects 20-34, wherein the one or more dissolved metal salts comprise metal sulfates, metal nitrates, metal chlorides, a combination thereof, and a combination with one or more additional metal salts.

Aspect 36. The method according to any one of Aspects 20-35, wherein the one or more metal salts comprise metal salts selected from the group consisting of Cu(NO₃)₂.6H₂O, Mn(NO₃)₂.4H₂O, Co(NO₃)₂.6H₂O, Cr(NO₃)₃, Fe(NO₃)₃, a combination thereof, and a combination thereof with one or more additional salts.

Aspect 37. The method according to any one of Aspects 20-36 further comprising annealing the substrate and the one or more metal layers at an elevated temperature, wherein the elevated temperature is from about 200° C., about 300° C. to about 1000° C., or from 300° C. to about 900° C., or from 300° C. to about 800° C. or from 400° C. to about 800° C., or from about 500° C. to about 800° C., or from about 600° C. to about 800° C., or from about 700° C. to about 800° C.

Aspect 38. The method according to any one of Aspects 20-37, wherein the annealing time is from about 30 minutes to 360 minutes, or from about 30 minutes to about 300 minutes, or, from about 60 minutes to about 240 minutes, or from about 120 minutes to about 180 minutes, or about 240 minutes, or about 300 minutes.

Aspect 39. A method of making the solar absorbing material of any one of Aspects 1-21, the method comprising: contacting the substrate with an aqueous solution comprising dissolved salts of two or more metals, wherein the aqueous solution is in contact with a first counter electrode, a working electrode, and a reference electrode; and applying a first current or current density across the working electrode and counter electrode for a first period of time sufficient to deposit a first metal layer on the substrate, wherein the first metal layer comprises the two or more metals.

Aspect 40. The method of Aspect 39 further comprising contacting the substrate with a second aqueous solution comprising dissolved salts of two or more metals, wherein the second aqueous solution is in contact with a second counter electrode, a second working electrode, and a second reference electrode; and applying a second current or current density across the second working electrode and second counter electrode for a second period of time sufficient to deposit a second metal layer on the substrate, wherein the second metal layer comprises the two or more metals, wherein the salts of the two or more metals in the second aqueous solution may be different from the salts of the two or more metals in the aqueous solution.

Aspect 41. The method of Aspect 39 or Aspect 40 further comprising contacting the substrate with a third aqueous solution comprising dissolved salts of two or more metals, wherein the third aqueous solution is in contact with a third counter electrode, a third working electrode, and a third reference electrode; and applying a third current or current density across the third working electrode and third counter electrode for a third period of time sufficient to deposit a third metal layer on the substrate, wherein the third metal layer comprises the two or more metals, wherein the salts of the two or more metals in the third aqueous solution may be different from the salts of the two or more metals in the aqueous solution or from the salts of the two or more metals in the second aqueous solution.

Aspect 42. The method of any one of Aspects 39-41 wherein the second period of time is shorter than the first period of time.

Aspect 43. The method of any one of Aspects 39-42 wherein the third period of time is shorter than the second period of time.

Aspect 44. The method of any one of Aspects 39-43 wherein the second current density is smaller than the first current amperage.

Aspect 45. The method of any one of Aspects 39-44 wherein the third current density is smaller than the second current amperage.

Aspect 46. The method of any one of Aspects 39-45 wherein the first current density is from about 5 to about 10 mA/cm².

Aspect 47. The method of any one of Aspects 39-46 wherein the second current density is from about 1 to about 3 mA/cm².

Aspect 48. The method of any one of Aspects 39-47 wherein the third current density is from about 0.1 to about 1 mA/cm².

Aspect 49 A solar absorbing material comprising: a substrate and an annealed coating overlying the substrate comprising a light-absorbing multiscale fractal textured surface, wherein the multiscale fractal textured surface comprises features spanning a length scale range from Lₘᵢₙ to Lₘₐₓ, a fractal dimension (“D”) and a scaling constant (“G”), wherein Lₘᵢₙ, Lₘₐₓ, D, and G, are measured based upon a linear best fit curve of a power spectrum of the Weierstrass-Mandelbrot (W-M) function and a power spectrum of a profilometric scan of the multiscale fractal textured surface.

Aspect 50. The solar absorbing material of Aspect 49 wherein D is from about 1.5 to about 1.95 about 1.96, about 1.97, about, 1.98, or about 1.99.

Aspect 51. The solar absorbing material of Aspect 49 or Aspect 50 wherein G is from about 0.1 micron to 3 microns, or 3.1 microns, or 3.2 microns, or 3.3 microns, or 3.4 microns, or 3.5 microns, or 3.6 microns, or 3.7 microns, or 3.8 microns, or 3.9 microns or 4 microns.

Aspect 52. The solar absorbing material of any one of Aspects 49-51 wherein the length scale ratio, Lₘₐₓ/Lₘᵢₙ, is from 1 to 10³.

Aspect 53. The solar absorbing material according any one of Aspects 1-19, wherein the material has a solar efficiency of about 90%, about 91%, about 92%, about 93%, about 94%, about 95%, about 96%, or about 98%.

Aspect 54. The solar absorbing material according any one of Aspects 1-19, wherein the multiscale fractal textured surface comprises features spanning a length scale range from Lₘᵢₙ to Lₘₐₓ, a fractal dimension (“D”) and a scaling constant (“G”), wherein Lₘᵢₙ, Lₘₐₓ, D, and G, are measured based upon a linear best fit curve of a power spectrum of the Weierstrass-Mandelbrot (W-M) function and a power spectrum of a profilometric scan of the multiscale fractal textured surface.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### General Procedures

Preparation of coatings: Robust and durable textured absorber coatings were fabricated on Inconel 625 substrate by electrodeposition method. An Autolab PGSTAT128N potentiostat supplied by ECO Chemie, Utrecht, The Netherlands, was used to perform the electrodeposition experiments. As received, Inconel 625 substrate of size 3.5 cm×3.5 cm, without any surface treatment, was used for the deposition, exhibiting average solar absorptance, α=0.434 and thermal emittance, ε=0.190. Before the deposition, substrates were ultrasonically cleaned for 10 min in deionized water and 2-propanol, respectively, and dried in air to remove any dirt and grease from the substrate surface. Copper manganese oxide (CuMnO) films were deposited from an aqueous solution containing Cu(NO₃)₂.6H₂O (0.05M), Mn(NO₃)₂.4H₂O (0.05M), and 0.1M KNO₃. Copper cobalt oxide (CuCoO) films were deposited from Cu(NO₃)₂.6H₂O (0.05M), Co(NO₃)₂.4H₂O (0.05M), and 0.1M KNO₃ aqueous solation. The electrodeposition process employed the traditional three-electrode system, with 15 cm² platinum mesh as a counter electrode (CE), Ag/AgCl as a reference electrode (RE), and a metal substrate sheet with an exposed area of 12.25 cm² as the working electrode (WE). For this experiment, CE is placed in the middle, and RE and WE have been placed 2 cm apart on each side of CE. The electrodeposition allowed for a range of overpotentials from 0.5 V to 1.3 V for the 60-sec duration. The deposited copper manganese and copper-cobalt samples were annealed at 500° C. and 300° C., respectively, for 2 hours in the air in a box furnace for oxidation and black absorber formation.

In a similar manner, the following annealed coatings were prepared: MnO, CoO, YO, CuCoO, CuNiO, CoMnO, FeMnO, CuCrO, CuMnCoO, CuCrMnO, CuCrCoO, and CuFeMnO.

### Microstructural Characterization

Field emission scanning electron microscopy (FESEM, Model LEO-Zeiss FESEM) was used to study the morphology of the coatings; images were taken at different magnifications to study the multiscale structures developed during electrodeposition. Cross-sectional images were recorded using the Helios-600 S.E.M. instrument. For cross-sectional imaging, Focused ion beam (FIB) sectioning was employed before SEM imaging. Structural characterization of the black coatings was performed using an X-ray diffractometer (XRD) (Bruker D8 Advance) with Cu Kα radiation (λ=1.5406 Å) at 40 kV voltage and 40 mA current.

A Zygo NewView 8000 series three-dimensional optical surface profiler was used to perform profilometric measurements on the prepared solar selective coatings. The instrument uses coherence scanning interferometry to measure the surface profile and provide non-contact, highly accurate and quick measurements of the prepared surfaces. Surface profile scans were performed at three different locations for each sample. The measured profile scan data was analyzed using the image and surface analysis software Gwyddion [40] and Matlab to obtain its averaged Fourier transform-based power spectrum. Using the obtained power spectra for the individual surfaces, their corresponding fractal parameters were calculated as described in Section 2.

### Optical Characterization

Spectral total absorptance, α(λ) (=1−R(λ)), of the absorber coatings was recorded with a Cary 5000 UV-Vis-NIR spectrophotometer equipped with an integrating sphere. Measurements were recorded in the 300 to 1500 nm wavelength range. A PTFE reflectance standard was used to calibrate the instrument before the actual measurement.

The average absorptance (α) of coatings was measured using a solar spectrum reflectometer (Model SSR) of Devices and Services, as per ASTM G173 standard. For the solar spectrum reflectometer, the source of the illumination was a tungsten-halogen lamp. The radiation reflected by the sample is measured at an angle of 37° from the normal, with four filtered detectors (UV, blue, red, and infrared). Solar spectrum measurement was achieved by adding up the four outputs in the appropriate proportions.

The solar spectrum reflectometer was calibrated using a standard sample. Hemispherical thermal emittance of the coating was measured using a Devices and Services (D&S) emissometer (Model AE). The emittance (ε) measured using this instrument is a corresponding temperature of 100° C. The emissometer was heated to 100° C. so that the sample to be measured need not be heated. At 100° C., the spectral range of the thermal radiation emitted from the surface is in the range of 3-30 μm. The instrument was calibrated using standard samples, and the emissometer has a repeatability of 0.01 units.

### Absorber Efficiency Calculation

The figure of merit (FOM), that is the absorber efficiency, η, of the different solar absorbers fabricated, was evaluated using the following expression for the solar absorber efficiency:

$$η = \frac{α Q - εσ {T}^{4}}{Q} \qquad ( 1 )$$

where α is the solar absorptance, Q is the irradiance on the receiver, ε is the thermal emittance, σ is the Stefan-Boltzmann constant, and T is the absolute surface temperature in units of Kelvin. In this study, we calculated the efficiency of solar absorbers for Gen 3 power tower systems by assuming the black body temperature T=750° C. and the concentration ratio C to be 1000 (1000 sun), which are the target temperature and concentration ratio, respectively, for Gen 3 CSP systems.

### Water Immersion Endurance Test

Water endurance of electrodeposited coatings was performed as per the ASTM D870-15 standards. Coatings were fully immersed in flowing water in a container for one hour at room temperature. After one hour, coatings were removed from the water and examined for any color change, blistering loss of adhesion, softening, or embrittlement. The absorptance and emittance of coatings were recorded before and after the water immersion test. After removing the coatings from the water bath, optical properties were tested within 5 minutes and again after 24 hours.

### Water Quenching Test

In the water quenching test, samples at a high temperature of 750° C. were taken and immediately immersed into cold water. After removing the sample from the water, samples are examined for any color change, peel-off, and degradation. The absorptance and emittance of coatings were recorded before and after the water quenching test.

### Adhesion Test

To determine the mechanical durability of electrodeposited coatings on Inconel 625 substrates adhesion test was performed as per the ASTM 3359 standard. Adhesion test was done using 3M 250 Scotch® tape. The sample was first adhered to a desk by applying adhesive tapes on the sides. The Scotch® 250 tape was then applied on the surface. A one-pound weight was rolled on the tape and then removed; this process was repeated two times. Absorptance and emittance of the samples were measured before and after the adhesion test.

### Irradiance Cycling Protocol

Absorber samples were heated with a flux of 40 W/cm² to reach a targeted temperature of 700° C. for each cycle during testing. Solar absorptance (αₛ) and total hemispherical emittance at 700° C. (ε_{700° C.}) were determined using a Surface Optics Corporation 401 Solar Reflectometer and ET 100 Emissometer, respectively. Three measurements were recorded for αₛ and ε_{700° C.} during each optical measurement (which provided a standard deviation). Real time sample surface temperature was determined using a Micro-Epsilon IR camera. Pre-cycle sample emissivity was input into the IR camera for the temperature measurement. The test protocol was as follows:
1) Expose the sample to solar flux until the sample reaches 700° C. for a maximum of 250 seconds
2) Shield the sample from the incident flux for 10 seconds.
3) Repeat steps 1 and 2 1000 times.
4) Record post exposure optical properties

### Fractal Morphology Studies—Comparison of Calculated and Experimental Results

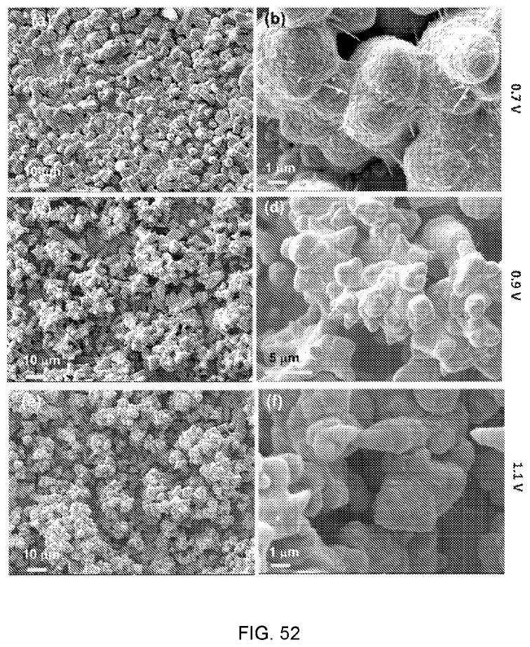

FIG. 52 shows SEM images of CuO samples deposited at overpotentials of 0.7 V (FIG. 52 Panels a,b), 0.9 V (FIG. 52 Panels c, d) and 1.1 V (FIG. 52 Panels e, f), each at two different magnifications. The fabricated CuO coatings demonstrate randomly rough morphologies with progressively increasing hierarchical asperity structures at multiple scales, with increasing deposition voltage. The images at 0.7 V show incipient rough textures that are homogeneously distributed on the surface. The magnified image shows globular asperity structures with minimal depth to the features. With increasing voltage to 0.9 V, a more intricate network of multiscale asperity structures is seen to evolve, and at 1.1 V, a complex three-dimensional network of the multiscale textured surface is evident with the presence of multiple internal reflection surfaces for enhanced light capture.

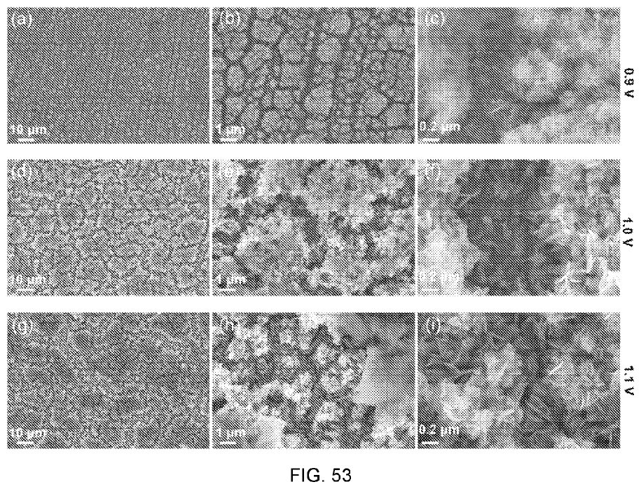

Similarly, FIG. 53 shows the scanning electron micrographs of CuMnO coatings deposited at overpotentials of 0.9 V, 1.0 V, and 1.1 V, each at three different magnifications. For CuMnO coatings, at lower voltages, just a few micrometer-sized, island-like particles form on the substrate surface, as seen in FIG. 53 (a-c). At a deposition voltage of 1.0 V, the microclusters formed at lower voltages begin branching in coatings, as seen in FIG. 53 (d-f). CuMnO coatings deposited at 1.1V, on the other hand, have a distinct multiscale, multi-layered structure FIG. 53 (g-i)) with compact micro-sized layers at the top (FIG. 53 (g)) and nano flower-like structures at the bottom (FIG. 53 (i)). The low magnification image in FIG. 53 (g) shows that these micro-features are interconnected and formed clusters, leaving a few micro gaps between them that act as light traps. The cascade of texture features from the micro-sized top layers to the nano-sized flowers at the bed of the asperities makes the textured surface required for a perfect solar absorber.

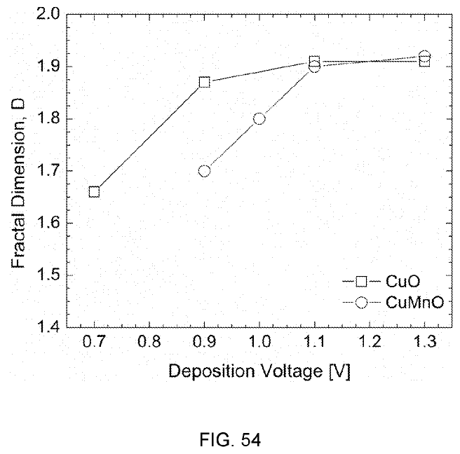

It is clear from FIG. 52 and FIG. 53, therefore, that tailored multiscale structures with a significant fractal component may be fabricated through proper selection of the fabrication parameters. FIG. 54 examines the fractal nature of the textured surfaces quantitatively in terms of the variation of the fractal dimension of CuO and CuMnO coatings fabricated with increasing deposition voltages. For both coatings, the fractal dimension is seen to increase from about 1.6 for deposition at the smaller voltage to about 1.93 at the higher voltages. The fractal dimension for CuO coating deposited at 0.7 V is 1.66, but as the deposition voltage increased, the fractal dimension increased from 1.88 for 0.9 V to about 1.92 for 1.1V and remained near that level for coatings deposited at 1.3 V. Similarly, the fractal dimension of the deposited CuMnO coatings also increased with an increase in the deposition voltage: at the deposition voltage values of 0.9 V, 1.0 V, 1.1 V, and 1.3 V, the corresponding fractal dimension values are 1.7, 1.8, 1.9, and 1.92.

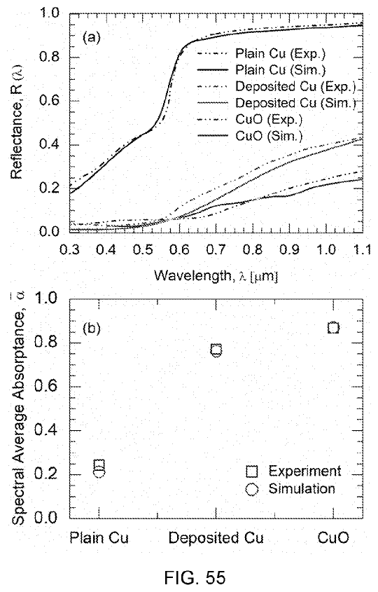

The computational model developed as described above was used to simulate the spectral reflectance, R(λ), and spectral average absorptance (α̅) of the different fractal-textured coatings and surfaces from the literature and compared to the respective experimental measurements. FIG. 9 compares measured and simulated spectral reflectance (FIG. 55 (a)) as well as average spectral absorptance (FIG. 54) variation for plain untextured copper (Cu), fractal-textured copper electrodeposited at 1.1 V, and 1.1 V electrodeposited and heat-treated copper-oxide (CuO) coatings over the wavelength ranging from 300 nm to 1100 nm. The experimental data for the different surfaces were obtained from Jain and Pitchumani [9]. The fractal dimension D for the electrodeposited copper and CuO is obtained from FIG. 54 as 1.92 corresponding to a deposition voltage of 1.1 V, and the coating thickness is 3 μm.

The data for the real and imaginary parts of the refractive index (n and k) for bare Cu and CuO were taken from Rakić et al. [41] and Özer et al. [42].

FIG. 55(a) shows that the reflectance of plain untextured Cu is high (black lines), which is reduced substantially by fractal surface texturing (red lines). Heat treatment of the deposited Cu coatings creates a black oxide, CuO, which further reduces the reflectance (blue lines). In all the cases, the simulated reflectance values follow the measured spectra closely over the entire wavelength range considered. Further, FIG. 9b presents the spectral average absorptance of the plain untextured Cu, electrodeposited, fractal-textured Cu, and fractal-textured CuO coatings. The measured and simulated spectral average absorptance for plain Cu, fractal-textured Cu and fractal-textured CuO are 0.24, 0.77, and 0.86 (measured) and 0.21, 0.76, and 0.87 (simulated), respectively, which demonstrates an excellent agreement between the physics-based simulations and the experimental measurements for all Cu based coatings. The measured thermal emittance of deposited Cu and CuO ranged from 0.15 to 0.66 at the deposition voltage from 0.3 V to 1.1 V [9].

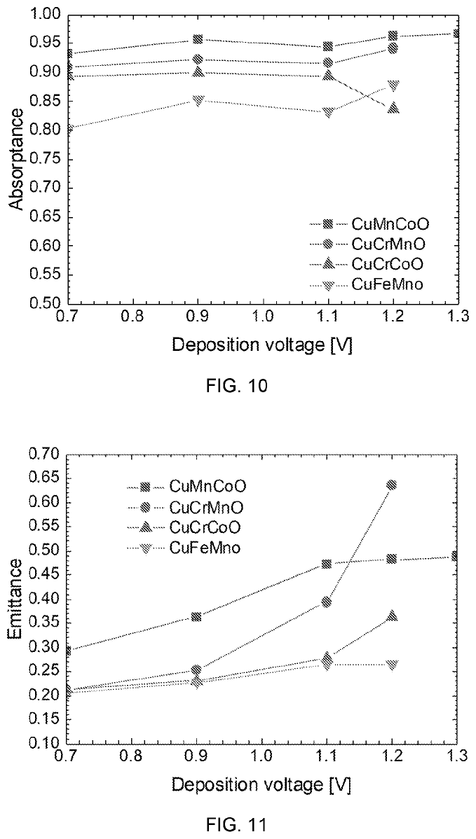

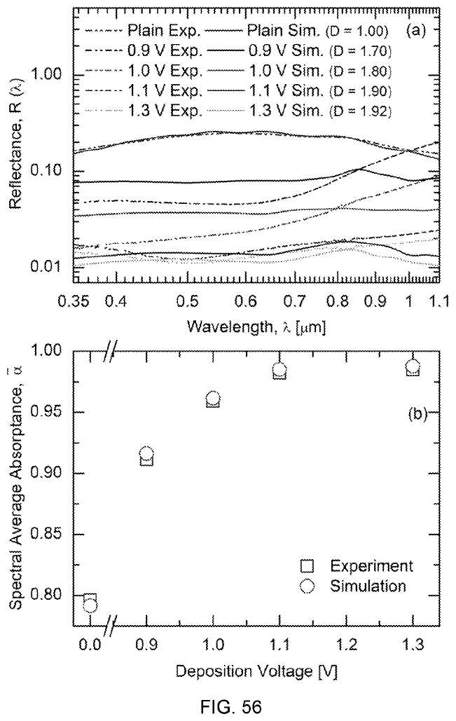

Following the same format as in FIG. 55, FIG. 56 compares the measured and simulated spectral reflectance (FIG. 56 (a)) and spectral average absorptance (FIG. 10b) of CuMnO coatings over a range of electrodeposition voltage and, in turn, fractal dimensions as provided in the legend of FIG. 56 (a). For plain untextured CuMnO

coating, the experimental measurements were taken from Falahatgar et al. [33], while for all other textured coatings, the measurements were conducted in this study as discussed above. The numerical simulation for the fractal textured CuMnO coatings was conducted based on the fractal characterization of the deposited CuMnO solar selective coatings presented in the previous section: the fractal dimension for deposited CuMnO at 0.9 V, 1.0 V, 1.1 V, and 1.3 V are 1.7, 1.8, 1.9, 1.92, respectively. The refractive index values with wavelength were taken from [30-34], and the measured coating thickness of 3 μm was used in the numerical simulations.

The measured thermal emittance of CuMnO ranged from 0.15 to 0.50 at the deposition voltage from 0.3 V to 1.3 V. The optimized CuMnO, which was deposited at 1.1V, exhibits an emittance of only 0.41. In comparison, even in pristine conditions, black absorber coatings applied using alternative techniques, such as spray deposition, are reported to exhibit emittance greater than 0.8 [43,44].

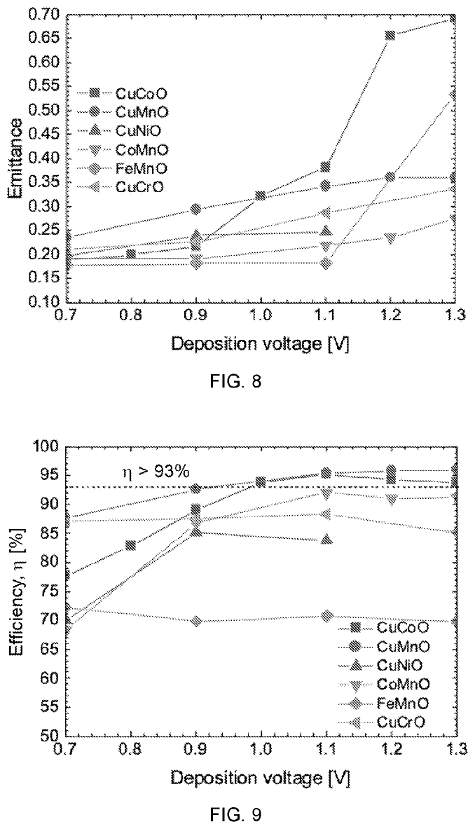

FIG. 56 compares experimentally measured and numerically simulated spectral reflectance profiles for CuMnO over the wavelength range of 350 nm to 1100 nm. The measured and simulated variations are in general agreement and follow the correct trend that the reflectance decreases with increasing fractal texturing. The differences between the simulated and measured profiles are attributed to the variabilities in the reported refractive index values, n, and k. A further comparison is presented in FIG. 56 in terms of the spectral average absorptance variation with the electrodeposition voltage. It was seen in FIG. 7 that increasing voltage led to more multiscale features on the coatings, which corresponded to increasing fractal dimension value (FIG. 8). FIG. 56 reveals the increasing absorptance with respect to the fractal texturing achieved by the increasing deposition voltage, ranging from α̅≈0.8 for a plain, untextured surface to α̅≈0.985 for an electrodeposition voltage of 1.1 V. The results point to the effect of fractal texturing that leads to an extremely high absorptance value of much significance to Gen3 CSP applications. Furthermore, FIG. 10b shows that the numerically simulated values of α̅=0.791, 0.916, 0.961, 0.985 and 0.987 match the measured spectral average absorptance values of 0.796, 0.911, 0.959, 0.982, and 0.985 for the plain [33] and the increasingly fractal textured CuMnO solar selective coatings.

The results presented demonstrate that fractal textured surfaces considerably improve the absorptance (from 0.2 to 0.985 for CuMnO, for example). At the same time, the thermal emittance of these surfaces increases only modestly (from 0.15 to 0.50 for CuMnO), which demonstrates the exceptional solar selective characteristic of the surface. The enhanced performance of the coatings would contribute to increased efficiency and reduced cost of the CSP system.

The present article focused on the modeling of the absorptance of the fractal textured surfaces. Simulation of the thermal emittance requires the spectral refractive index, n and k, in the long wavelength (infrared) range, which is not available. Therefore, the modeling considered only absorptance, which is of greater significance for the air-stable absorber coatings needed for power tower applications at the Gen3 CSP temperature. Although the coatings are developed for open-air power tower applications, these can also be used for evacuated tubes. If the refractive index profiles were available in the longer wavelength range, the modeling methodology for the emittance remains the same as that presented in this article and may be pursued in a future study.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A solar absorbing material comprising: a substrate and an annealed coating overlying the substrate comprising an electrodeposited metal oxide layer comprising two metals selected from the group consisting of cobalt (Co), copper (Cu), chromium (Cr), iron (Fe), manganese (Mn), and nickel (Ni), on a surface of the substrate, wherein the metal oxide layer is a light-absorbing multiscale fractal textured surface, and wherein the efficiency of the solar absorbing material is from 90% to 99%.

2. The solar absorbing material of claim 1 wherein the electrodeposited metal oxide layer comprises three metals.

3. The solar absorbing material of claim 1 wherein the coating comprises two electrodeposited metal oxide layers.

4. The solar absorbing material of claim 1 wherein the coating comprises three electrodeposited metal oxide layers.

5. The solar absorbing material of claim 1 wherein the efficiency reduced by from about 1% to about 10% after a period of time of exposure to 750° C. in air at atmospheric pressure.

6. The solar absorbing material of claim 1 wherein the solar efficiency is reduced by from about 1% to about 10% after exposure to ultraviolet radiation as measured by the Absorber Cycling Protocol.

7. The solar absorbing material of claim 1 wherein the solar efficiency is reduced by from about 1% to about 10% by thermal shock as measured by the Water Quenching Test.

8. The solar absorbing material of claim 1 wherein the solar efficiency is reduced by from about 1% to about 10% as an angle of incidence of light on the solar-absorbing material is reduced from 65 deg to 10 deg relative to a plane in non-intersecting coincidence to the surface.

9. The solar absorbing material of claim 1, wherein the metals are selected from the group consisting of cobalt (Co), copper (Cu), nickel (Ni) and manganese (Mn).

10. The solar absorbing material of claim 1, wherein the metals are selected from the group consisting of Cu and Co.

11. The solar absorbing material of claim 1, wherein the metals are selected from the group consisting of Cu and Mn.

12. The solar absorbing material of claim 1, wherein the metal oxide coating has a thickness on the surface of the substrate from about 1 micron, about 2 micron, about 2.5 micron, about 3 micron and up to about 2.5 micron, about 3 micron, about 3.5 micron, about 4 micron, or more.

13. The solar absorbing material of claim 1, wherein the substrate comprises a conductive metal substrate.

14. (canceled)

15. (canceled)

16. The solar absorbing material of claim 1, wherein the substrate comprises one or more elements selected from the group consisting of chromium, manganese, iron, cobalt, nickel, copper, and zinc.

17. (canceled)

18. (canceled)

19. (canceled)

20. A method of making the solar absorbing material of claim 1, the method comprising: contacting the substrate with an aqueous solution comprising dissolved salts of two or more metals, wherein the aqueous solution is in contact with a first counter electrode, a working electrode, and a reference electrode; and applying a first voltage across the working electrode and counter electrode for a first period of time sufficient to deposit a first metal layer on the substrate, wherein the first metal layer comprises the two or more metals.

21. The method of claim 20 further comprising contacting the substrate with a second aqueous solution comprising dissolved salts of two or more metals, wherein the second aqueous solution is in contact with a second counter electrode, a second working electrode, and a second reference electrode; and applying a second voltage across the second working electrode and second counter electrode for a second period of time sufficient to deposit a second metal layer on the substrate, wherein the second metal layer comprises the two or more metals, wherein the salts of the two or more metals in the second aqueous solution may be different from the salts of the two or more metals in the aqueous solution.

22. The method of claim 20 further comprising contacting the substrate with a third aqueous solution comprising dissolved salts of two or more metals, wherein the third aqueous solution is in contact with a third counter electrode, a third working electrode, and a third reference electrode; and applying a third voltage across the third working electrode and third counter electrode for a third period of time sufficient to deposit a third metal layer on the substrate, wherein the third metal layer comprises the two or more metals, wherein the salts of the two or more metals in the third aqueous solution may be different from the salts of the two or more metals in the aqueous solution or from the salts of the two or more metals in the second aqueous solution.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A method of making the solar absorbing material of claim 1, the method comprising: contacting the substrate with an aqueous solution comprising dissolved salts of two or more metals, wherein the aqueous solution is in contact with a first counter electrode, a working electrode, and a reference electrode; and applying a first current or current density across the working electrode and counter electrode for a first period of time sufficient to deposit a first metal layer on the substrate, wherein the first metal layer comprises the two or more metals.

40. The method of claim 39 further comprising contacting the substrate with a second aqueous solution comprising dissolved salts of two or more metals, wherein the second aqueous solution is in contact with a second counter electrode, a second working electrode, and a second reference electrode; and applying a second current or current density across the second working electrode and second counter electrode for a second period of time sufficient to deposit a second metal layer on the substrate, wherein the second metal layer comprises the two or more metals, wherein the salts of the two or more metals in the second aqueous solution may be different from the salts of the two or more metals in the aqueous solution.

41. The method of claim 39 further comprising contacting the substrate with a third aqueous solution comprising dissolved salts of two or more metals, wherein the third aqueous solution is in contact with a third counter electrode, a third working electrode, and a third reference electrode; and applying a third current or current density across the third working electrode and third counter electrode for a third period of time sufficient to deposit a third metal layer on the substrate, wherein the third metal layer comprises the two or more metals, wherein the salts of the two or more metals in the third aqueous solution may be different from the salts of the two or more metals in the aqueous solution or from the salts of the two or more metals in the second aqueous solution.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
